(19) United States
(12) Patent Application Publication
(10) Pub. No.: US 2024/0109229 A1
(43) Pub. Date: Apr. 4, 2024

(54) HYDROGEL FILM ATTACH

(71) Applicant: Senseonics, Incorporated, Germantown, MD (US)

(72) Inventors: Philip Huffstetler, Germantown, MD (US); Sanat Mohanty, Germantown, MD (US); Giacomo Fornasini, Germantown, MD (US); Robert Atwood, Germantown, MD (US)

(73) Assignee: Senseonics, Incorporated, Germantown, MD (US)

(21) Appl. No.: 18/479,548

(22) Filed: Oct. 2, 2023

Related U.S. Application Data
(60) Provisional application No. 63/378,175, filed on Oct. 3, 2022.

(51) Int. Cl. B29C 45/00; B29C 45/26; B32B 27/00; B32B 37/12

(52) U.S. Cl. CPC B29C 45/0001; B29C 45/2602; B32B 27/00; B32B 37/12; B29C 2045/2604

(57) ABSTRACT

Apparatuses and methods for attaching a hydrogel film to a product. The hydrogel film may be produced by injecting a monomer solution into a mold, polymerizing the monomer solution in the mold to produce a hydrogel sheet, and cutting the hydrogel sheet to produce one or more hydrogel films. The process may include attaching a hydrogel film of the one or more hydrogel films to a product. Attaching the hydrogel sheet to the product may include applying an adhesive onto the product, placing a first edge of the hydrogel film in the adhesive on the product, and placing a second edge of the hydrogel film in the adhesive on the product.

### CROSS-REFERENCE TO RELATED APPLICATION

The present application claims the benefit of priority to U.S. Provisional Application Ser. No. 63/378,175, filed on Oct. 3, 2022, which is incorporated herein by reference in its entirety.

### BACKGROUND

### Field of Invention

The present disclosure relates to apparatuses and methods for attaching a hydrogel film to a product.

### Discussion of the Background

One example of a product that includes one or more hydrogel films is an analyte sensor. An analyte sensor may be part of an analyte monitoring system, which may be used to monitor analyte levels, such as analyte concentrations (e.g., glucose concentrations). One type of analyte monitoring system is a continuous analyte monitoring system. A continuous analyte monitoring system measures analyte levels throughout the day and can be very useful in the management of diseases, such as diabetes.

A hydrogel film of an analyte sensor may include analyte indicator molecules that produce a detectable property (e.g., an optical property) indicative of the presence and/or amount of an analyte (e.g., glucose) in a fluid (e.g., interstitial fluid) in proximity to the hydrogel film. For example, the analyte indicator molecules may reversibly bind the analyte and, when irradiated with excitation light, emit an amount of light (e.g., fluorescent light) indicative of whether the analyte is bound. The analyte sensor may include a detector (e.g., a photodetector) that outputs a signal indicative of the detectable property produced by the analyte indicator molecules (e.g., the amount of light emitted by the analyte indicator molecules).

For products that include hydrogel films (e.g., analyte sensors such as glucose sensors), the products must be manufactured by growing the hydrogel on the product.

### SUMMARY

For products that include hydrogel films (e.g., analyte sensors such as glucose sensors) manufactured by growing the hydrogel on the product, the hydrogel films must be grown on each individual product. In addition, if the hydrogel grown on the product is defective, the hydrogel cannot be removed from the product, and the product cannot be used. In this way, the conventional process of growing the hydrogel on the product may be wasteful because a defective hydrogel results in an otherwise fully functional product, which may be expensive, being thrown away. Moreover, in certain non-limiting embodiments, the thickness of the hydrogel grown on a product may have a preferred thickness (e.g., to hydrogel having a thickness no greater than approximately 500 microns (approximately 0.020″)).

Aspects of the invention may provide the advantage of a hydrogel film produced separate from the product. The separately produced hydrogel film may be inspected before attachment to the product so that only successfully produced hydrogel films are attached to products. In some aspects, an attached hydrogel film may be removable from the product such that, if the attached hydrogel film fails an inspection, the hydrogel film may be removed and another hydrogel film attached. In this way, the product, which may be expensive and may be otherwise fully functional, need not be thrown away due to an issue with an attached hydrogel film.

Some aspects of the invention may provide the advantage of a scalable hydrogel film production process. In some aspects, many hydrogel films may be made by producing a hydrogel sheet and then cutting the hydrogel sheet into hydrogel films. In some aspects, a greater range of hydrogel film thicknesses may be possible when the hydrogel film is produced separate from the product (as compared to the range of thicknesses possible for hydrogels grown on the product).

One aspect of the invention may provide a process including injecting a monomer solution into a mold. The process may include polymerizing the monomer solution in the mold to produce a hydrogel sheet. The process may include cutting the hydrogel sheet to produce one or more hydrogel films. The process may include attaching a hydrogel film of the one or more hydrogel films to a product.

In some aspects, the mold may include first and second plates and one or more clips configured to hold the first and second plates together, and the monomer solution may be injected between the first and second plates. In some aspects, the first plate may be a glass plate, the second plate may be a stamped plate, and the one or more clips may be plastic clips. In some aspects, the process may further include assembling the mold. In some aspects, injecting the monomer solution into the mold may include injecting the monomer solution into an injection port of the mold.

In some aspects, cutting the hydrogel sheet to produce one or more hydrogel films may include using a hydrogel cutting tool to partition the hydrogel sheet. In some aspects, using the hydrogel cutting tool to cut the hydrogel sheet may include providing the hydrogel sheet between a platform and a cut out sheet of the hydrogel cutting tool, the platform may include projections, and the cut out sheet may include openings that mate with the projections of the platform. In some aspects, using the hydrogel cutting tool to cut the hydrogel sheet may include inserting the projections of the platform into the openings of the cut out sheet.

In some aspects, attaching the hydrogel sheet to the product may include: applying an adhesive onto the product, placing a first edge of the hydrogel film in the adhesive on the product, and placing a second edge of the hydrogel film in the adhesive on the product. In some aspects, the adhesive may include silicones, siloxanes, acrylates, cyanoacrylates, epoxy resins, and/or polyurethanes. In some aspects, attaching the hydrogel sheet to the product may include rotating the product and pressing the hydrogel film against the product as the product rotates. The hydrogel sheet may include attachment through placing the film directly over an optics window of the product and wrapping the hydrogel film around the product.

In some aspects, attaching the hydrogel sheet to the product may include using a hydrogel film attachment tool. In some aspects, using the hydrogel film attachment tool may include holding the product in one or more product cradles of the hydrogel film attachment tool and using a roller of the hydrogel film attachment tool to attach the hydrogel film to the product. In some aspects, holding the product in the one or more product cradles may include using one or more magnets of the hydrogel film attachment tool to hold the product in the one or more product cradles. In some aspects, the hydrogel film attachment tool may include multiple cavities for holding the product(s). In some aspects, using the roller to attach the hydrogel film to the product may include rotating the roller 180 degrees in one of the clockwise and counterclockwise directions and then rotating the roller 180 degrees in the other of the clockwise and counterclockwise directions.

In some aspects, the process may further include determining whether the hydrogel film passes an inspection before attaching the hydrogel film to the product. In some aspects, determining whether the hydrogel film passes the inspection may include determining whether the hydrogel film includes a threshold amount of analyte indicator molecules.

In some aspects, the process may further include determining whether the hydrogel film attached to the product passes an inspection. In some aspects, the process may further include determining that the hydrogel film attached to the product does not pass the inspection, removing all or a portion of the hydrogel film from the product, and attaching another hydrogel film to the product.

In some aspects, the process may further include drying the product including the hydrogel film attached to the product.

In some aspects, the process may further include applying a protective material to the hydrogel film attached to the product. In some aspects, the protective material may be configured to reduce deterioration of analyte indicator molecules of the hydrogel film. In some aspects, the protective material may be configured to catalyze degradation of reactive oxygen species (ROS). In some aspects, the protective material may include platinum, palladium, iridium, molybdenum, and/or silver. In some aspects, the process may further include applying a second protective material to the hydrogel film attached to the product. In some aspects, the second protective material may include iridium, palladium, silver, and/or molybdenum.

In some aspects, the product may be a sensor.

In some aspects, the hydrogel film of the one or more hydrogel films may be a first hydrogel film, the first hydrogel film may be attached to a first portion of the product, and the first hydrogel film may include first analyte indicator molecules configured to reversibly bind a first analyte and emit an amount of first emission light indicative of an amount of the first analyte indicator molecules that have reversibly bound the first analyte. In some aspects, the process may further include attaching a second hydrogel film to a second portion of the product. In some aspects, the second hydrogel film may include second analyte indicator molecules configured to reversibly bind a second analyte and emit an amount of second emission light indicative of an amount of the second analyte indicator molecules that have reversibly bound the second analyte, and the second analyte may be different than the first analyte. In some aspects, the monomer solution may be a first monomer solution, the mold may be a first mold, the hydrogel sheet may be a first hydrogel sheet, and the one or more hydrogel films may be one or more first hydrogel films. In some aspects, the process may further include injecting a second monomer solution into a second mold, and the second monomer solution may include the second analyte indicator molecules. In some aspects, the process may further include polymerizing the second monomer solution in the second mold to produce a second hydrogel sheet. In some aspects, the process may further include cutting the second hydrogel sheet to produce one or more second hydrogel films, and the second hydrogel film attached to the product may be one of the one or more second hydrogel films.

Another aspect of the invention may provide a process of using a hydrogel film attachment tool to attach a hydrogel film to a product. The process may include holding the product in one or more product cradles of the hydrogel film attachment tool. The process may include using a roller of the hydrogel film attachment tool to attach the hydrogel film to the product.

In some aspects, holding the product in the one or more product cradles may include using one or more magnets of the hydrogel film attachment tool to hold the product in the one or more product cradles. In some aspects, using the roller to attach the hydrogel film to the product may include rotating the roller 180 degrees in one of the clockwise and counterclockwise directions and then rotating the roller 180 degrees in the other of the clockwise and counterclockwise directions.

Yet another aspect of the invention may provide a hydrogel film attachment tool. The hydrogel film attachment tool may include one or more product cradles configured to hold a product. The hydrogel film attachment tool may include a roller configured to attach a hydrogel film to the product.

In some aspects, the tool may further include one or magnets configured to hold the product in the one or more product cradles.

These and other embodiments encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIGS. 1A and 1B are front and side views, respectively, of a device including a product and one or more hydrogel films and embodying aspects of the present invention.

FIGS. 2A and 2B are perspective views of devices including one and two hydrogel films, respectively, attached to a product and embodying aspects of the present invention.

FIG. 3 is a block diagram illustrating a device including a hydrogel film attached to a housing of a product embodying aspects of the present invention.

FIG. 4 is a flowchart illustrating a non-limiting example of a process for producing and attaching a hydrogel film embodying aspects of the present invention.

FIG. 5 is a flowchart illustrating a non-limiting example of a process for producing a hydrogel sheet embodying aspects of the present invention.

FIGS. 6A-6D illustrate steps for producing a hydrogel sheet embodying aspects of the present invention.

FIG. 7 is a perspective view of a hydrogel cutting tool embodying aspects of the present invention.

FIG. 8 illustrates a hydrogel film embodying aspects of the present invention.

FIG. 9 is a flowchart illustrating a non-limiting example of a process for attaching a hydrogel film to a product embodying aspects of the present invention.

FIG. 10A illustrates an oval flat tip for applying adhesive to a product embodying aspects of the present invention.

FIG. 10B illustrates adhesive applied to a product embodying aspects of the present invention.

FIG. 10C illustrates a spreading tool for applying adhesive to a product embodying aspects of the present invention.

FIGS. 10D and 10E illustrate perspective and cross-sectional views of an adhesive application tool for applying adhesive to a product embodying aspects of the present invention.

FIG. 10F illustrates a first edge of a hydrogel film placed in adhesive on a product embodying aspects of the present invention.

FIG. 10G illustrates first and second edges of a hydrogel film placed in adhesive on a product embodying aspects of the present invention.

FIGS. 11A-11C illustrate a hydrogel film attachment tool embodying aspects of the present invention.

FIGS. 11D-11I illustrate a hydrogel film attachment tool embodying aspects of the present invention.

FIGS. 12A-12C illustrate a hydrogel film attachment tool embodying aspects of the present invention.

FIGS. 12D-12G illustrate a roller of a hydrogel film attachment tool embodying aspects of the present invention.

FIG. 12H illustrates a roller actuator of a hydrogel film attachment tool embodying aspects of the present invention.

FIG. 12I illustrates a product cradle, shaft, and mount of a hydrogel film attachment tool embodying aspects of the present invention.

FIG. 12J illustrates a product cradle, shaft, and mount of a hydrogel film attachment tool embodying aspects of the present invention.

FIGS. 12K-12M illustrate a product cradle of a hydrogel film attachment tool embodying aspects of the present invention.

FIG. 12N illustrates a product cradle of a hydrogel film attachment tool embodying aspects of the present invention.

FIG. 13 is a flowchart illustrating a non-limiting example of a process for attaching a hydrogel film to a product embodying aspects of the present invention.

FIGS. 14A-14C illustrate a hydrogel film attachment tool embodying aspects of the present invention.

FIG. 15 is a flowchart illustrating a non-limiting example of a process for attaching a hydrogel film to a product embodying aspects of the present invention.

FIG. 16 shows the experimental results of repeatability and reproducibility testing of devices including a hydrogel film attached to a product embodying aspects of the present invention.

FIG. 17 shows experimental results of functionality testing of devices including a hydrogel film attached to a product post-sterilization embodying aspects of the present invention.

FIGS. 18A and 18B show the experimental results of stability testing on hydrogel films grown on products and hydrogel films attached to products embodying aspects of the present invention, respectively.

### DETAILED DESCRIPTION

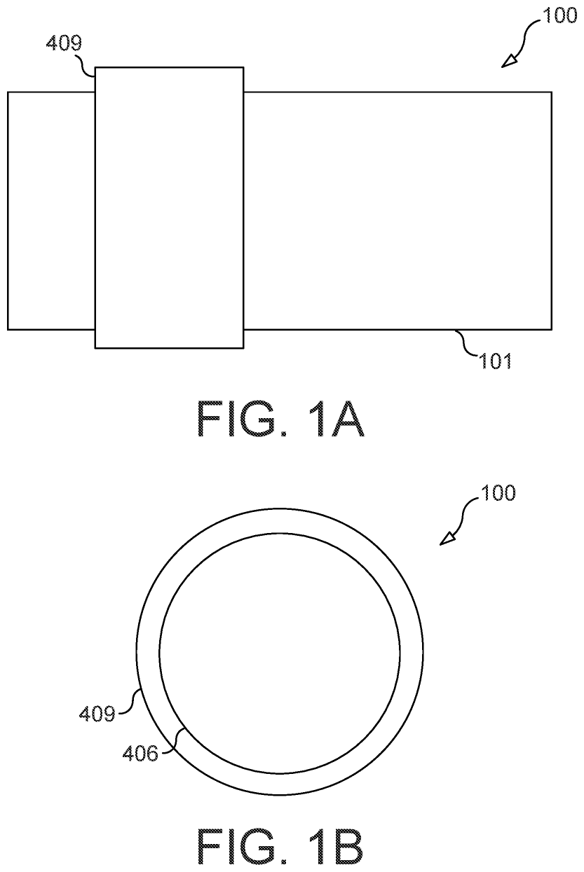

FIGS. 1A and 1B are front and side views, respectively, of a device 100 according to some aspects. In some aspects, the device 100 may include a product 101 and one or more hydrogel films 409 attached to the product 101. In some aspects, the hydrogel film 409 may include a network of polymer material. In some aspects, the network of polymer material may be a three-dimensional network. In some aspects, the polymer material may be hydrophilic polymer material. In some aspects, the polymer material may include cross-linked polymer chains.

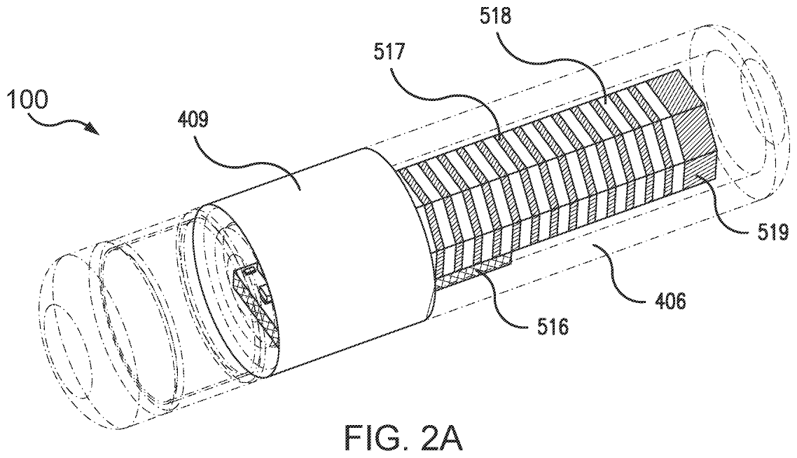

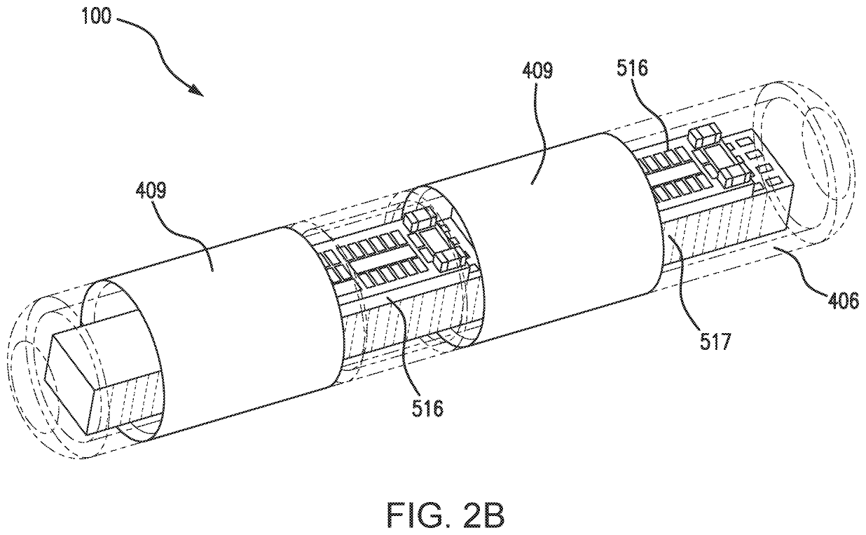

In some aspects, the device 100 may be an implant. In some aspects, the device 100 may be a sensor (e.g., an analyte sensor such as, for example and without limitation, a glucose sensor). In some aspects, as shown in FIGS. 2A and 2B, the device 100 may be a small, fully subcutaneously implantable sensor that takes one or more measurements indicative of analyte (e.g., glucose) levels in a first medium (e.g., interstitial fluid) of a living animal (e.g., a living human). However, this is not required, and, in some alternative aspects, the device 100 may be a partially implantable (e.g., transcutaneous) sensor or a fully external sensor. Similarly, it is not required that the device 100 be a sensor, and it is not required that the device 100 be implantable. In some sensor aspects, as shown in FIG. 2B, the device 100 may include multiple hydrogel films 409 (e.g., to create a multi-array platform). In some multiple hydrogel film 409 aspects, as shown in FIG. 2B, the multiple hydrogel films 409 may include a first hydrogel film 409 attached to a first portion of the device 100 and a second hydrogel film 409 attached to a second portion of the device 100. In some multiple hydrogel film 409 aspects, various analyte detecting moieties may be polymerized into the hydrogel films 409 and attached on specific portions of the device 101 (e.g., over specific photodiodes), which may provide for enhanced physiological range of analyte detection by the device 101.

In some aspects, as shown in FIGS. 2A and 2B, the product 101 may include a housing 406 (i.e., body, shell, capsule, or encasement), which may be rigid and biocompatible. In one non-limiting embodiment, the housing 406 may be a silicon tube. However, this is not required, and, in some other aspects, different materials and/or shapes may be used for the housing 406. In some embodiments, the product 101 may include a transmissive optical cavity. In some aspects, the transmissive optical cavity may be formed from a suitable, optically transmissive polymer material, such as, for example, acrylic polymers (e.g., polymethylmethacrylate (PMMA)), polyolefins (e.g. polypropylene (PP)), polyurethanes, and/or polysiloxanes/silicones and their copolymers. However, this is not required, and, in other embodiments, different materials may be used for the transmissive optical cavity.

In some aspects, as shown in FIGS. 2A and 2B, the one or more hydrogel films 409 may be attached (e.g., adhered) to the housing 406. In some aspects, the housing 406 may include one or more cutouts or recesses, and the one or more hydrogel films 409 may be located (partially or entirely) in the cutouts or recesses. In some aspects, the one or more hydrogel films 409 may be porous and may allow the analyte (e.g., glucose) in the first medium (e.g., interstitial fluid) to diffuse into the one or hydrogel films 409.

In some aspects, the device 100 may include a communication interface for conveying information (e.g., measurement data such as, for example, light and/or temperature measurements) and/or receiving information (e.g., commands). In some aspects, the communication interface of the device 100 may include an antenna for wireless communication. In some of alternative aspects (e.g., transcutaneous aspects), the communication interface may include a wired connection. In some aspects (e.g., wireless aspects), as shown in FIGS. 2A and 2B, the communication interface of the device 100 may include an inductor 517, which may be, for example, a ferrite based micro-antenna. In some aspects, as shown in FIG. 2A, the inductor 517 may include a conductor 518 in the form of a coil and a magnetic core 519. In some aspects, the core 519 may be, for example and without limitation, a ferrite core. In some embodiments, the inductor 517 may be connected to circuitry (e.g., an application specification integrated circuit (ASIC)) of the device 100 that is housed within the housing 406 of the product 101.

In some aspects, as shown in FIGS. 2A and 2B, the analyte sensor 100 may include one or more substrates 516. In some non-limiting embodiments, the substrate 516 may be a circuit board (e.g., a printed circuit board (PCB) or flexible PCB) on which one or more of circuit components (e.g., analog and/or digital circuit components) may be mounted or otherwise attached. However, in some alternative aspects, the substrate 516 may be a semiconductor substrate.

In some aspects, the product 101 may include one or more light sources (e.g., one or more of the light sources mounted on or fabricated within in the substrate 516) and/or one or more photodetectors (e.g., photodiodes, phototransistors, photoresistors, or other photosensitive elements). In some aspects, one or more photodetectors may be mounted on or fabricated in the substrate 516.

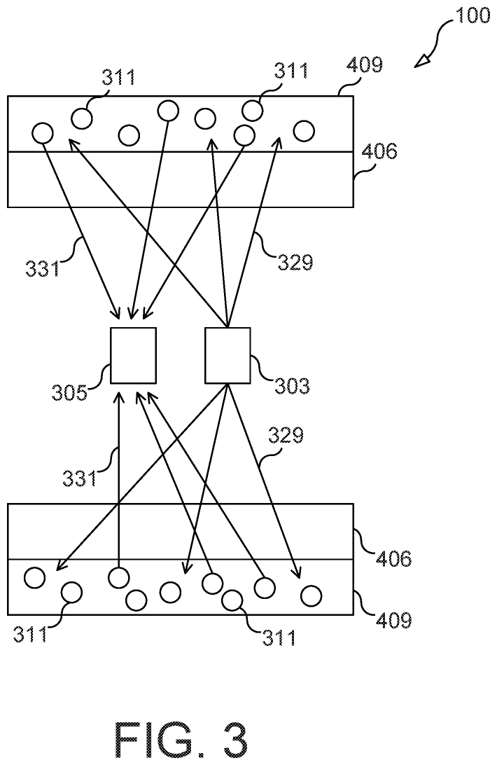

In some aspects, as shown in FIG. 3, the one or more hydrogel films 409 may include indicator molecules 311. In some aspects, the indicator molecules 311 may be fluorescent indicator molecules (e.g., having the chemical name 9-[N-[6-(4,4,5,5,-tetramethyl-1,3,2-dioxaborolano)-3-(trifluoromethyl)benzyl]-N-[3-(methacrylamido)propylamino]methyl]-10- [N-[6-(4,4,5,5,-tetramethyl-1,3,2-dioxaborolano)-3-(trifluoromethyl)benzyl]-N-[2-(carboxyethyl)amino]methyl]anthracene sodium salt) or light absorbing, non-fluorescent indicator molecules. In some aspects, the indicator molecules 311 may reversibly bind an analyte (e.g., glucose, oxygen, cardiac markers, low-density lipoprotein (LDL), high-density lipoprotein (HDL), or triglycerides). When an indicator molecule 311 has bound an analyte, the indicator molecule may become fluorescent, in which case the indicator molecule 311 is capable of absorbing (or being excited by) excitation light 329 and emitting light 331. When no analyte is bound, the indicator molecule 311 may be only weakly fluorescent.

In some aspects, as shown in FIG. 3, the device 100 (e.g., the product 101 of the device 100) may include a light source 303, which may be, for example, a light emitting diode (LED) or other light source that emits radiation, including radiation over a range of wavelengths that interact with the indicator molecules 311. In other words, the light source 303 may emit the excitation light 329 that is absorbed by the indicator molecules 311 in the hydrogel film 409. In some aspects, the light source 303 may be housed in the housing 406 of the product 101. In some aspects, the light source 303 may be mounted on or fabricated in the substrate 516.

In some aspects, as shown in FIG. 3, the device 100 may include one or more photodetectors 305 (e.g., photodiodes, phototransistors, photoresistors or other photosensitive elements). In some aspects, the one or more photodetectors 305 may be housed in the housing 406 of the product 101. In some aspects, the one or more photodetectors 305 may be mounted on or fabricated in the substrate 516. In some aspects, the one or more photodetectors 305 may be sensitive to light 331 (e.g., fluorescent light) emitted by the indicator molecules 311 such that a signal generated by one or more photodetector 305 in response thereto is indicative of the amount of light 331 emitted the indicator molecules 311 and, thus, the amount of analyte of interest (e.g., glucose). In some aspects, the excitation light 329 may have a different wavelength than the emission light 331.

In some multiple hydrogel film 409 aspects, the multiple hydrogel films 409 may include indicator molecules 311 that reversibly bind to the same analyte and, when irradiated with excitation light 329, emit an amount of excitation light 331 indicative of the analyte levels in the first medium (e.g., interstitial fluid) of the living animal. In some alternative multiple hydrogel film 409 aspects, one of the hydrogel films 409 may include first indicator molecules 311 that reversibly bind a first analyte (e.g., one of glucose, oxygen, cardiac markers, LDL, HDL, or triglycerides) and, when irradiated with excitation light 329, emit an amount of emission light 331 indicative of the amount of first indicator molecules 311 that have reversibly bound the first analyte, which may be indicative of first analyte levels in the first medium of the living animal. In some of these alternative multiple hydrogel film 409 aspects, another of the hydrogel films 409 may include second indicator molecules 311 that reversibly bind a second analyte (e.g., a different one of glucose, oxygen, cardiac markers, LDL, HDL, or triglycerides) and, when irradiated with excitation light 329, emit an amount of emission light 331 indicative of the amount of second indicator molecules 311 that have reversibly bound the second analyte, which may be indicative of second analyte levels in the first medium of the living animal.

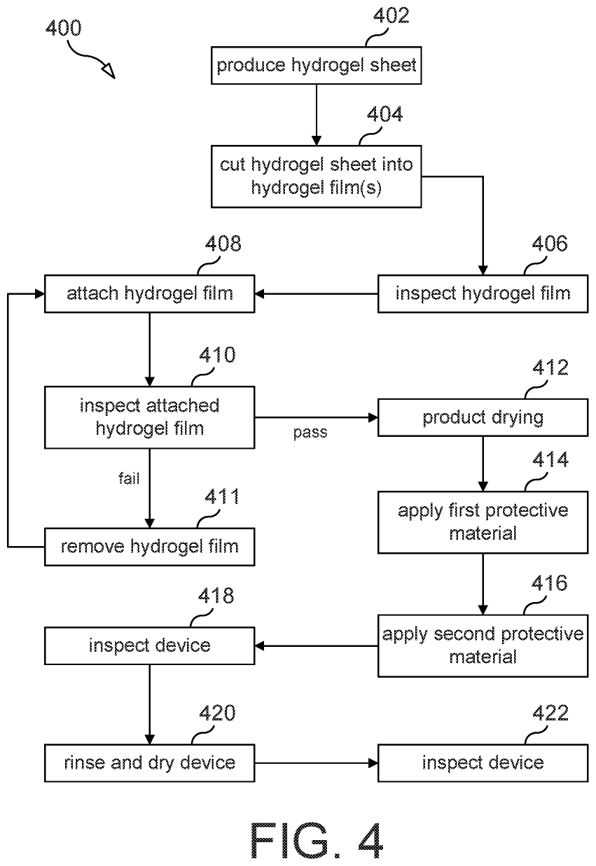

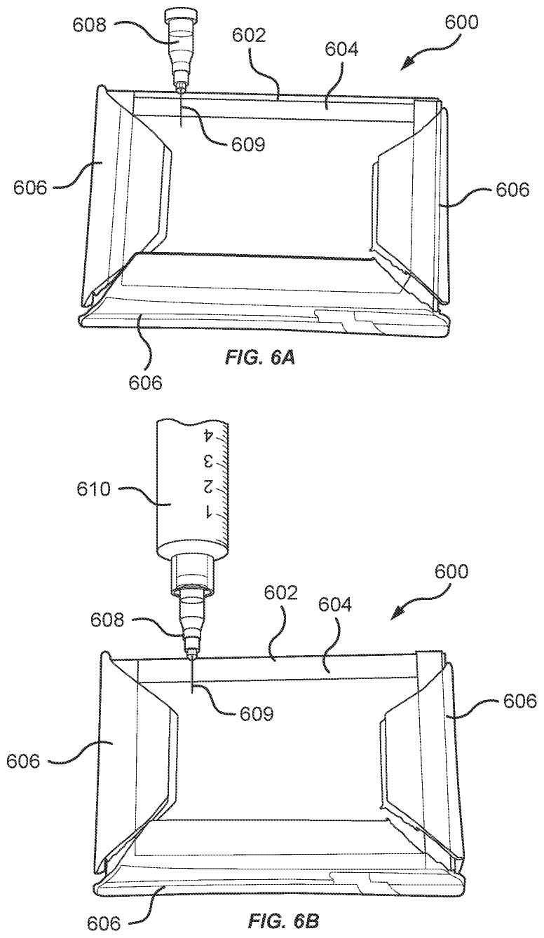

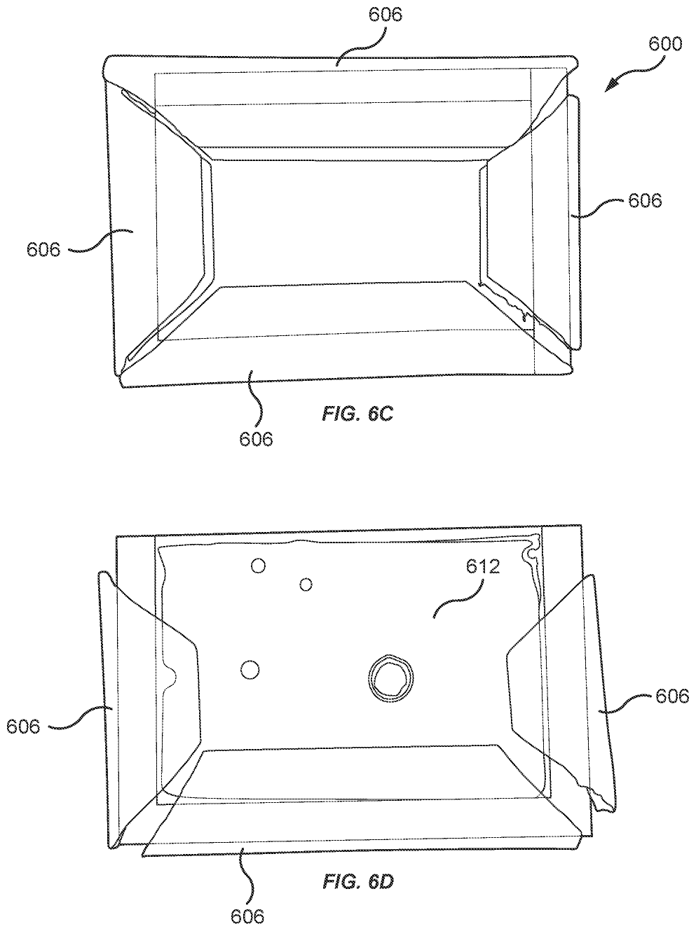

FIG. 4 is a flowchart illustrating a process 400 for producing and attaching a hydrogel film 409 according to some aspects. In some aspects, the process 400 may include a step 402 of producing a hydrogel sheet 612. FIG. 6D illustrates an example of a hydrogel sheet 612 that may be produced in the step 402 according to some aspects.

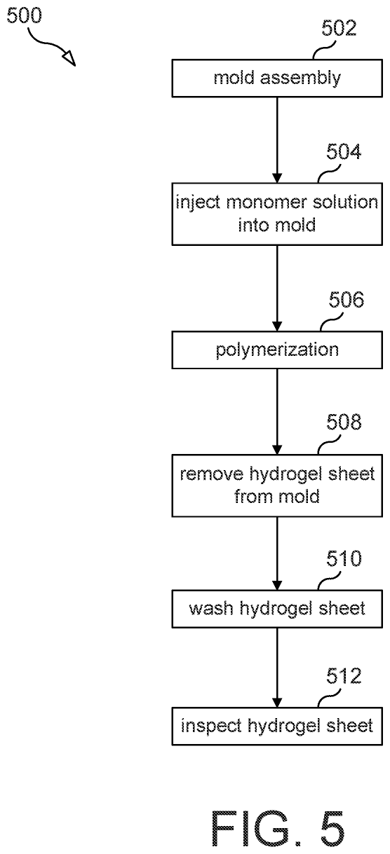

FIG. 5 is a flowchart illustrating a process 500 for producing a hydrogel sheet 612. In some aspects, the process 500 may be performed in step 402 of the process 400 illustrated in FIG. 4.

In some aspects, as shown in FIG. 5, the process 500 may include a step 502 of assembling a mold 600. In some aspects, as shown in FIG. 6A, the mold 600 may include first and second plates 602 and 604 and one or more clips 606 configured to hold the first and second plates 602 and 604 together (e.g., with the first plate 602 on top of the second plate 604). In some aspects, the first plate 602 may be a glass plate, the second plate 604 may be a stamped plate (e.g., a stamped metal plate), and/or the one or more clips 606 may be plastic clips. In some aspects, the mold 600 may include an injection port 608. In some aspects, as shown in FIG. 6A, the injection port 608 may include a needle 609. In some aspects, the needle 609 may be a flat tip needle (e.g., a 30-gauge flat tip needle). In some aspects, inclusion of the injection port 608 in the assembled mold 600 may make filling the mold 600 with the monomer solution 610 easier.

In some aspects, the second plate 604 may include raised edges (e.g., around the perimeter of the second plate 604). In some aspects, the raised edges of the second plate 604 may be in contact with the first plate 602 when the first and second plates 602 and 604 are held together by the one or more clips 606. In some aspects, when the first and second plates 602 and 604 are held together by the one or more clips 606, the first and second plates 602 and 604 may be separated from one another (e.g., other than at the raised edges of the second plate 604) such that a gap exists between the first and second plates 602 and 604. In some aspects, the amount of separation between the first and second plates 602 and 604 may correspond to a desired thickness of the hydrogel sheet 612 produced by the mold 600.

In some aspects, as shown in FIG. 5, the process 500 may include a step 504 of injecting a monomer solution 610 into the mold 600. In some aspects, as shown in FIG. 6B, the monomer solution 610 may be injected between the first and second plates 602 and 604. In some aspects, injecting the monomer solution 610 into the mold 600 in step 504 may include injecting the monomer solution 610 into the injection port 608 of the mold 600. In some aspects, the monomer solution 610 may be injected into the gap between the first and second plates 602 and 604 of the mold 600.

In some aspects, as shown in FIG. 6C, after the monomer solution 610 has been injected into the mold 600, the injection port 608 may be removed from the mold 600. In some aspects, as shown in FIG. 6C, after the monomer solution 610 has been injected into the mold 600, an additional clip 606 (or clips 606) may be added to the mold 600 (e.g., such that clips 606 on all sides of the mold 600 hold the first and second plates 602 and 604 together).

In some aspects, as shown in FIG. 5, the process 500 may include a step 506 of polymerizing the monomer solution 610 in the mold 600 to produce the hydrogel sheet 612. In some aspects, the step 506 may include curing the monomer solution 610.

In some aspects, as shown in FIG. 5, the process 500 may include a step 508 of removing the hydrogel sheet 612 from the mold 600. In some aspects, as shown in FIG. 6D, the step 508 may include removing one or more clips 606 from the mold 600. In some aspects, the step 508 may include removing the hydrogel sheet 612 from between the first and second sheets 602 and 604.

In some aspects, as shown in FIG. 5, the process 500 may include a step 510 of washing the hydrogel sheet 612.

In some aspects, as shown in FIG. 5, the process 500 may include a step 512 of inspecting the hydrogel sheet 612. In some aspects, if the hydrogel sheet 612 does not pass the inspection, all or a portion of the hydrogel sheet 612 may be discarded.

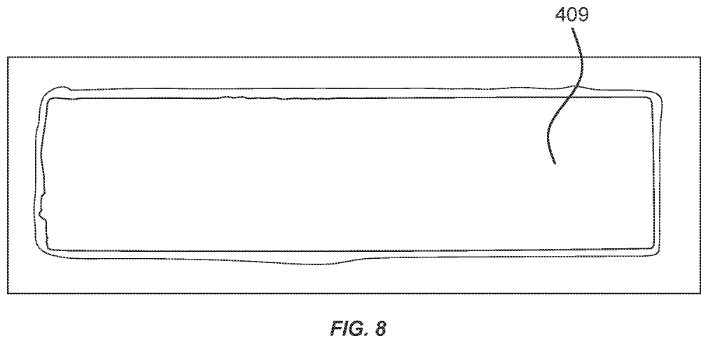

Returning to the process 400, in some aspects, as shown in FIG. 4, the process 400 may include a step 404 of cutting the hydrogel sheet 612 to produce one or more hydrogel films 409. FIG. 8 illustrates an example of a hydrogel film 409 that has been cut from a hydrogel sheet 612 according to some aspects.

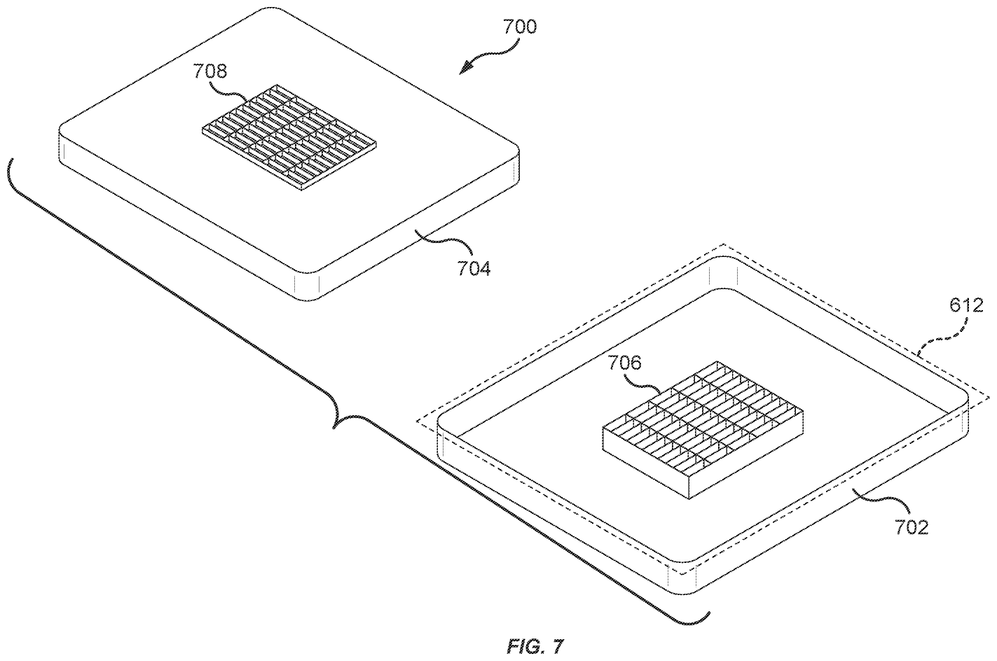

In some aspects, cutting the hydrogel sheet 612 to produce one or more hydrogel films 409 in step 404 may include using a hydrogel cutting tool 700 to partition the hydrogel sheet 612. In some aspects, as shown in FIG. 7, the hydrogel cutting tool 700 may include a platform 702 and a cut out sheet 704. In some aspects, the platform 702 may include projections 706. In some aspects, the cut out sheet 704 may include openings 708 that mate with the projections 706 of the platform 702. In some aspects, using the hydrogel cutting tool 700 to partition the hydrogel sheet 612 in step 404 may include, as shown in FIG. 7, providing the hydrogel sheet 612 between the platform 702 and the cut out sheet 704. In some aspects, using the hydrogel cutting tool 700 to partition the hydrogel sheet 612 may include inserting the projections 706 of the platform 702 into the openings 708 of the cut out sheet 704. In some aspects, the step 404 may include removing the one or more hydrogel films 409 from the hydrogel cutting tool 700.

In some aspects, as shown in FIG. 7, the platform 702 may include sixty projections 706, the cut out sheet 704 may include sixty openings 708, and the hydrogel cutting tool 700 may cut sixty hydrogel films 409 from the hydrogel sheet 612. However, this is not required, and, in some alternative aspects, the hydrogel cutting tool 700 may include a different number of projections 706, may include a different number of openings 708, and may cut a different number (e.g., 2, 4, 12, 20, 64, 100, 120, 200, etc.) of hydrogel films 409 from the hydrogel sheet 612.

In some aspects, the step 404 may include washing the hydrogel films 409 (e.g., before attaching the hydrogel films 409 to products 101). However, this is not required, and, in some alternative aspects, the step 404 may not include a step of washing the hydrogel films 409, and unwashed hydrogel films 409 may be attached to the products 101.

In some aspects, as shown in FIG. 4, the process 400 may include a step 406 of determining whether a hydrogel film 409 (e.g., a hydrogel film 409 cut from a hydrogel sheet 612 in step 404) passes an inspection (e.g., before attaching the hydrogel film 409 to the product 101). In some aspects, determining whether the hydrogel film 409 passes the inspection may include determining whether the hydrogel film 409 includes a threshold amount of indicator molecules 311 (e.g., analyte indicator molecules). In some aspects, determining whether a hydrogel film 409 passes the inspection may include determining whether an amount of free monomer remaining in the monomer solution 610 is above a threshold amount and, if so, determining that polymerization (e.g., in step 506) of the monomer solution 610 was not carried out correctly. In some aspects, if a hydrogel film 409 fails the inspection, the hydrogel film 409 may be removed from the process 400 and discarded.

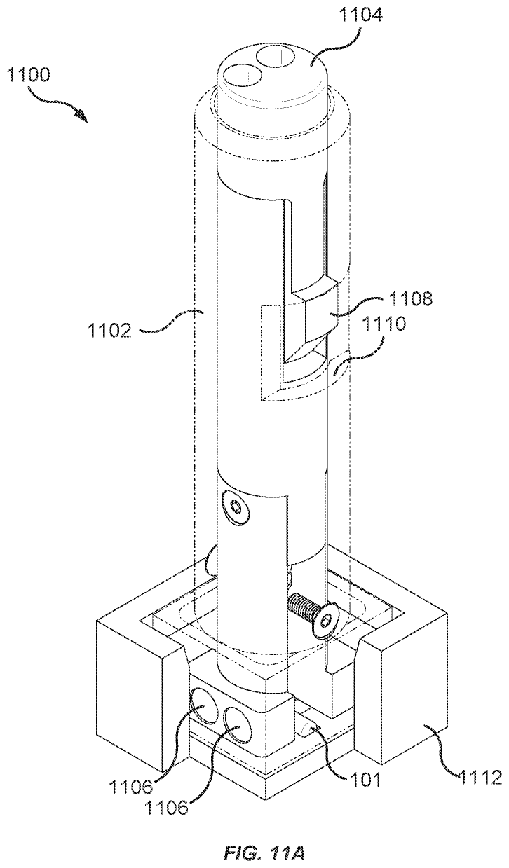

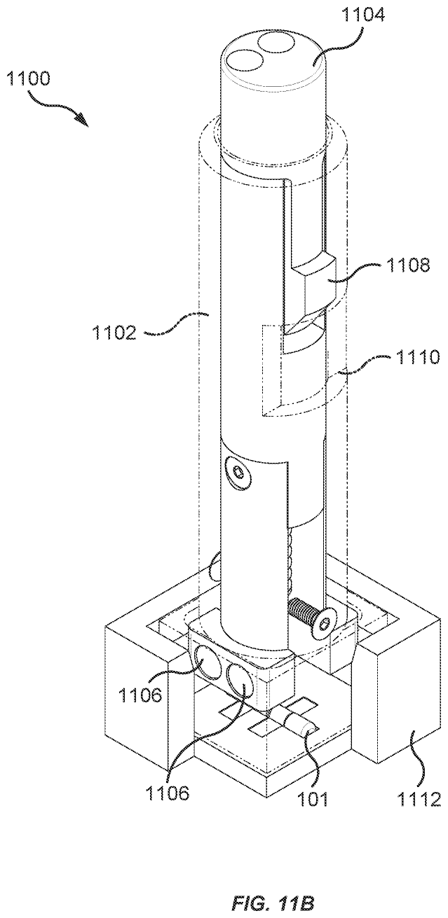

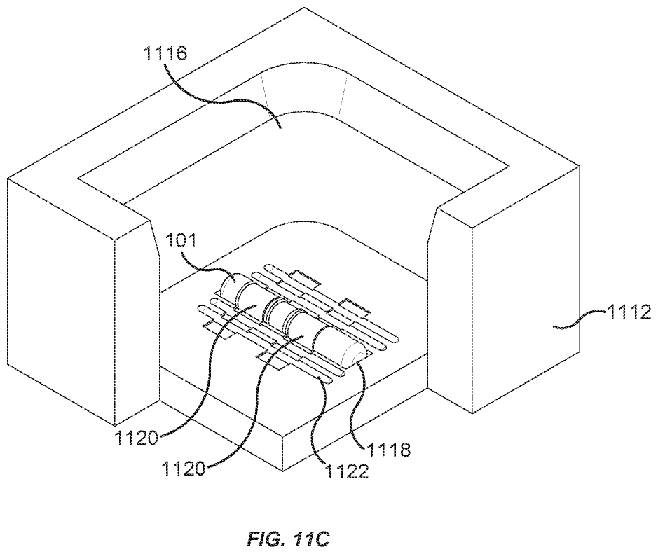

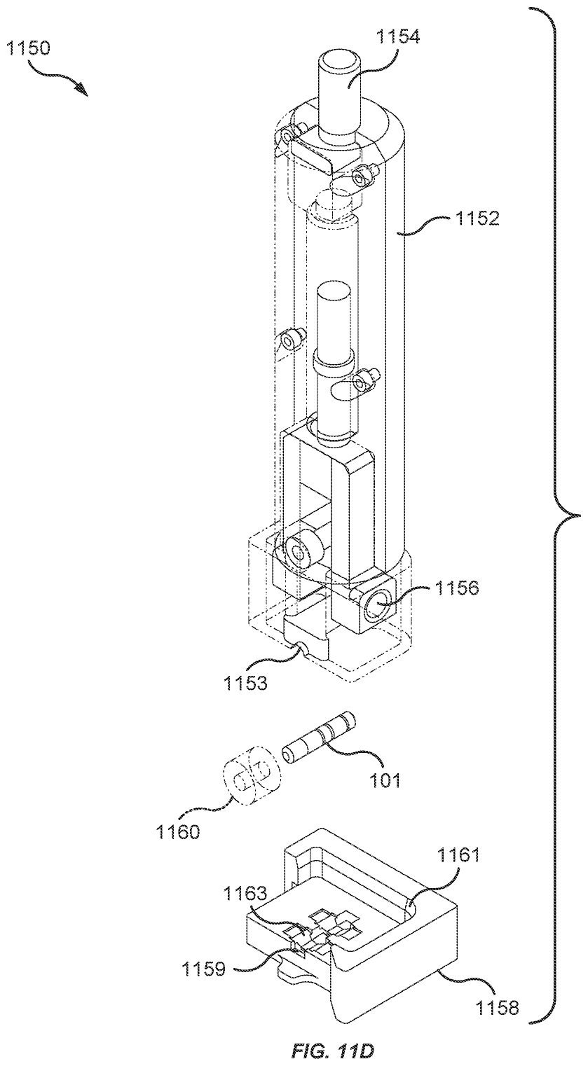

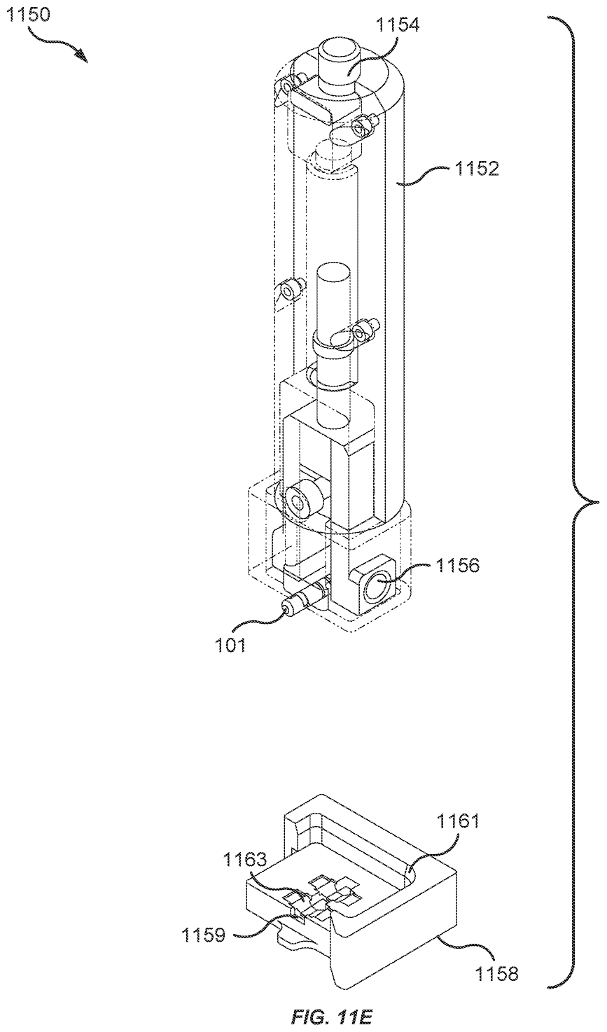

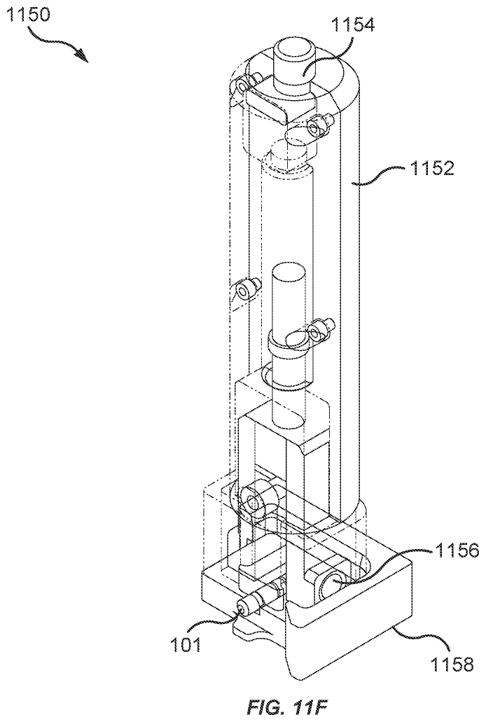

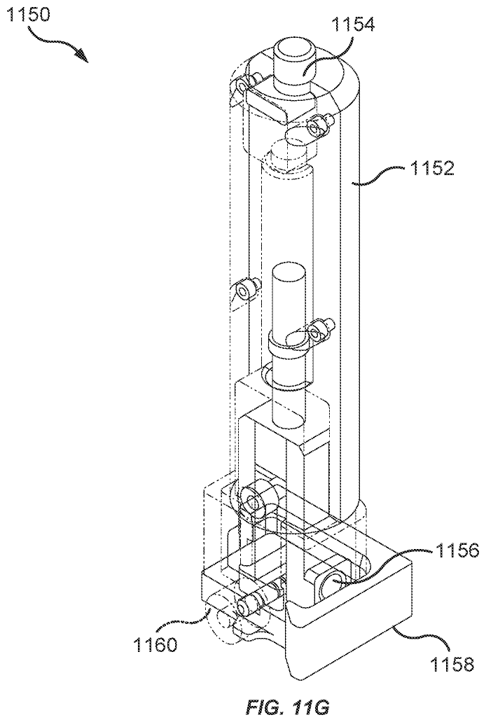

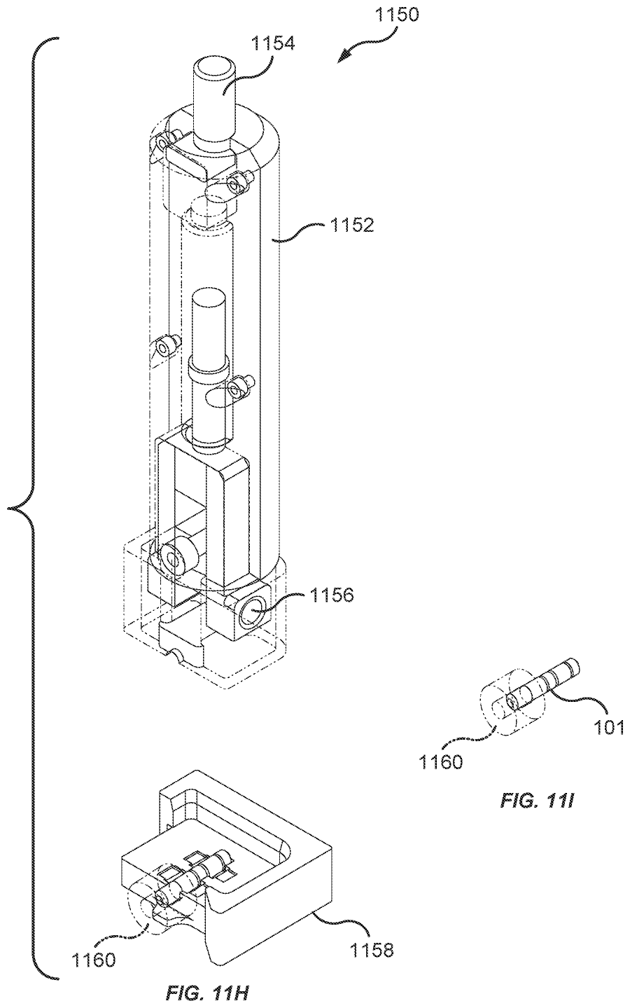

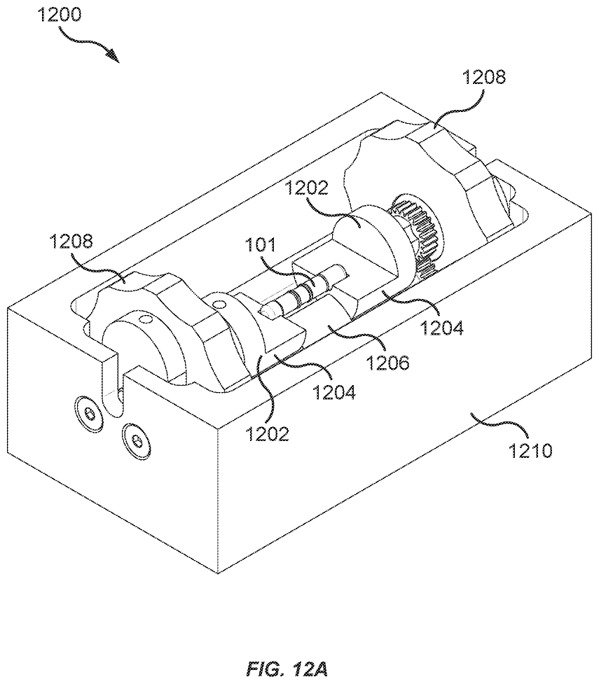

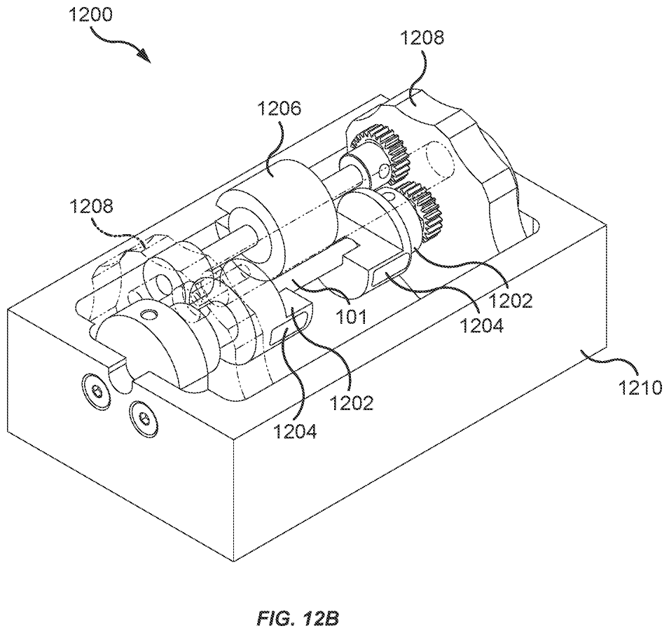

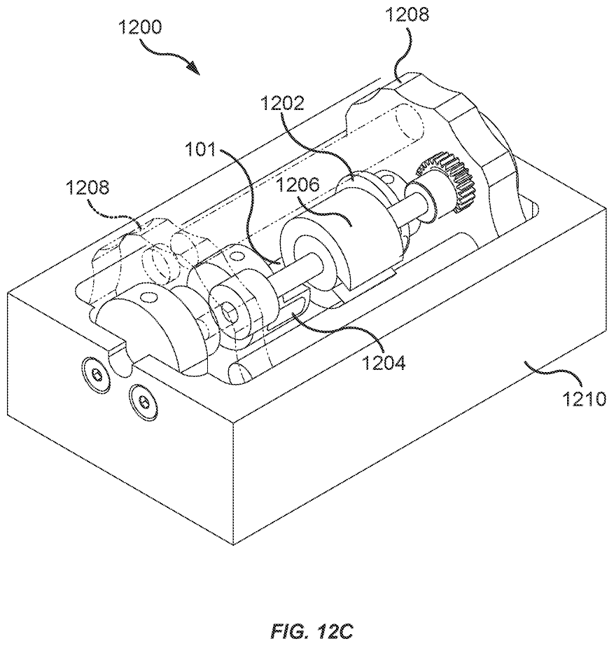

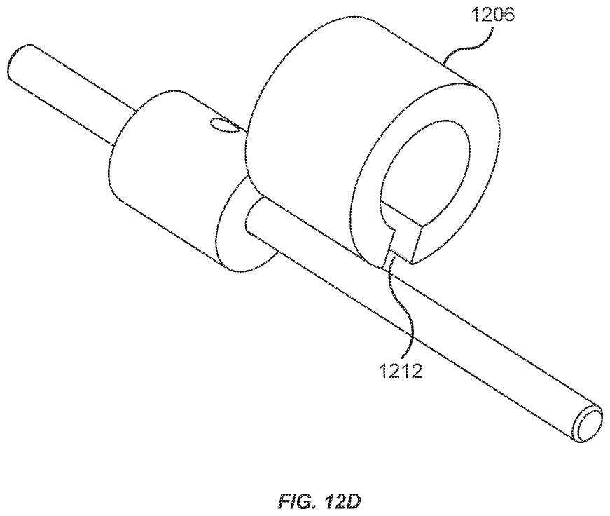

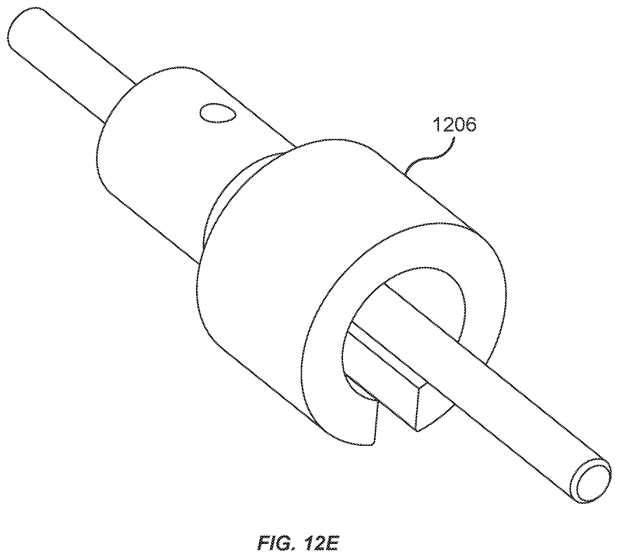

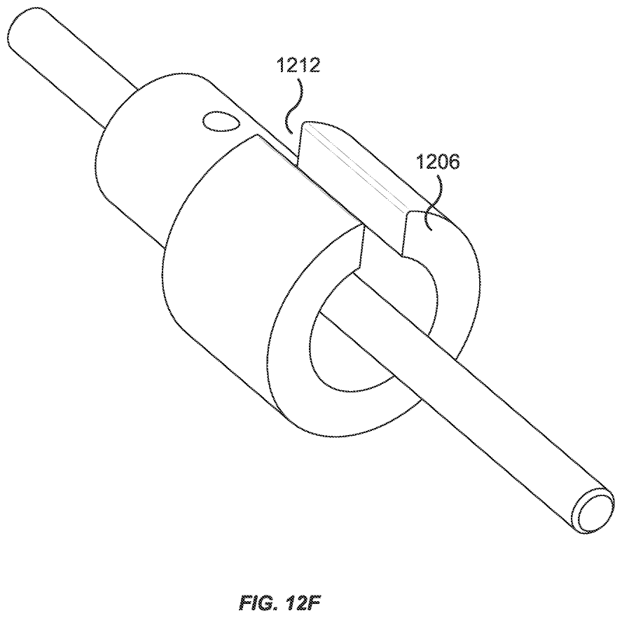

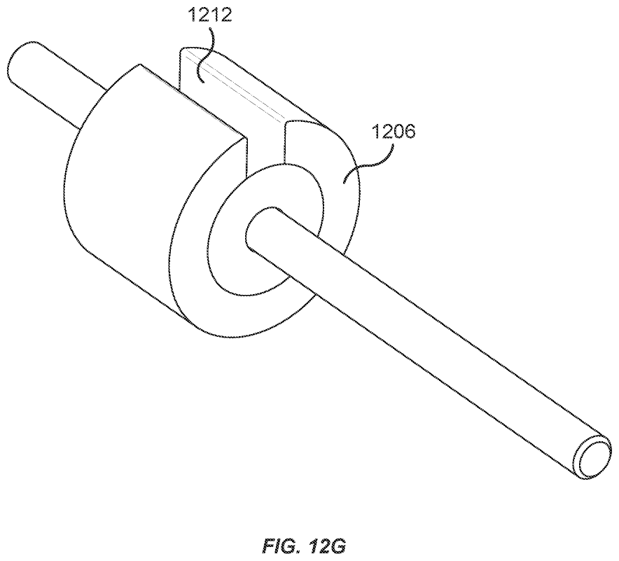

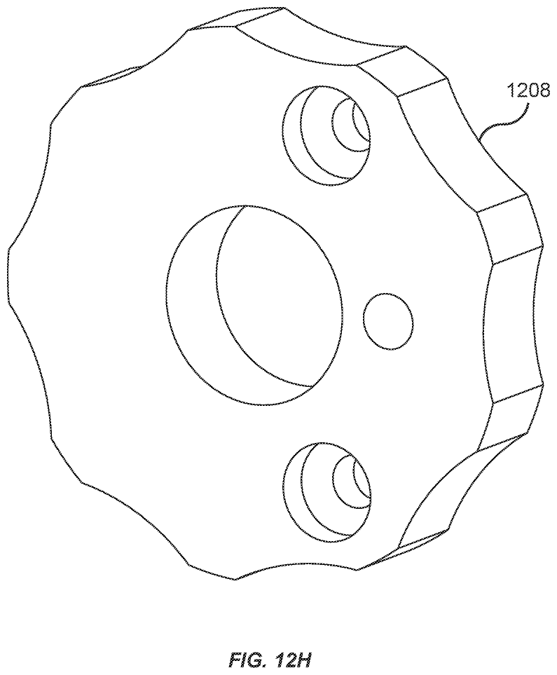

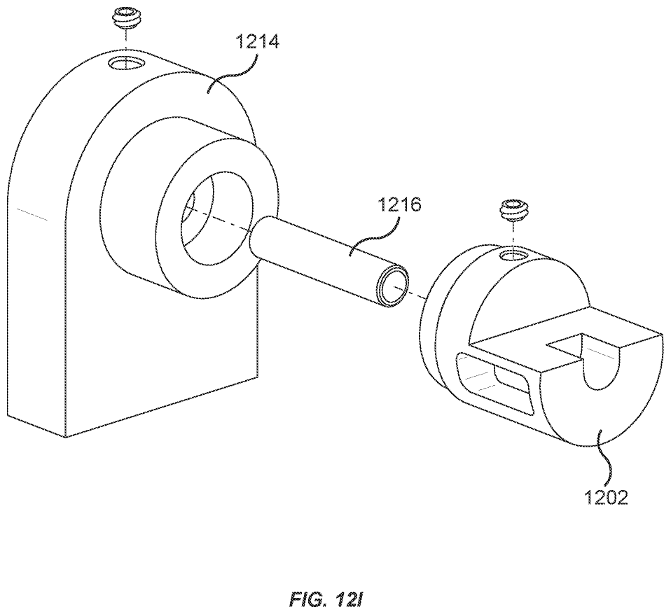

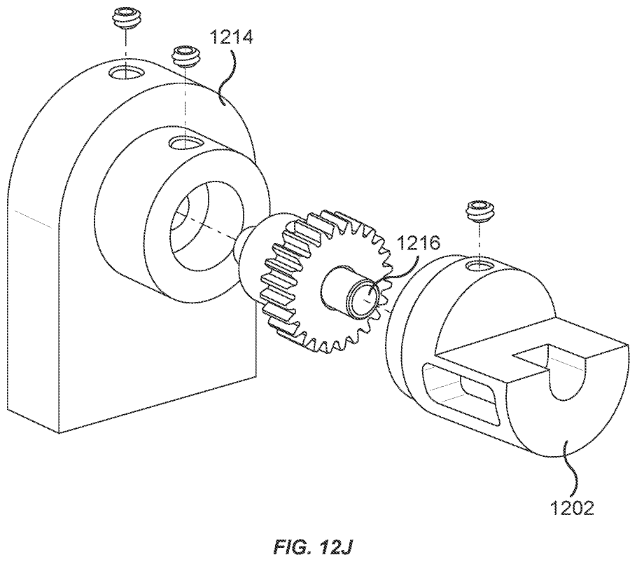

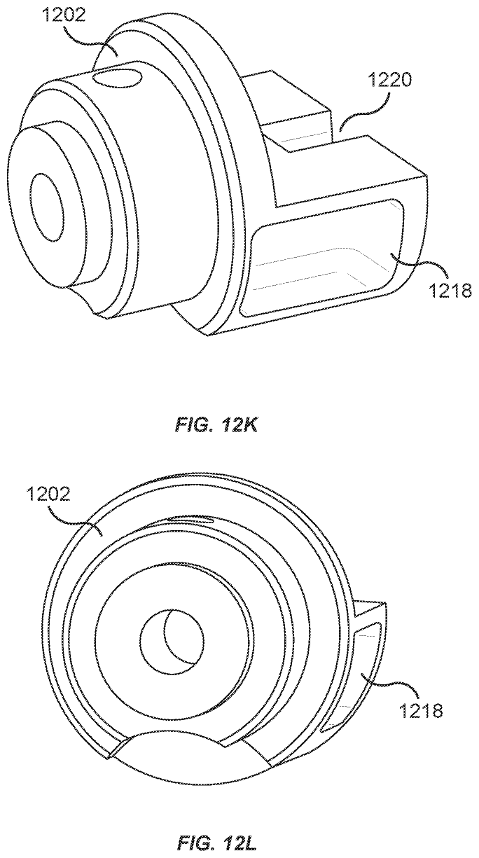

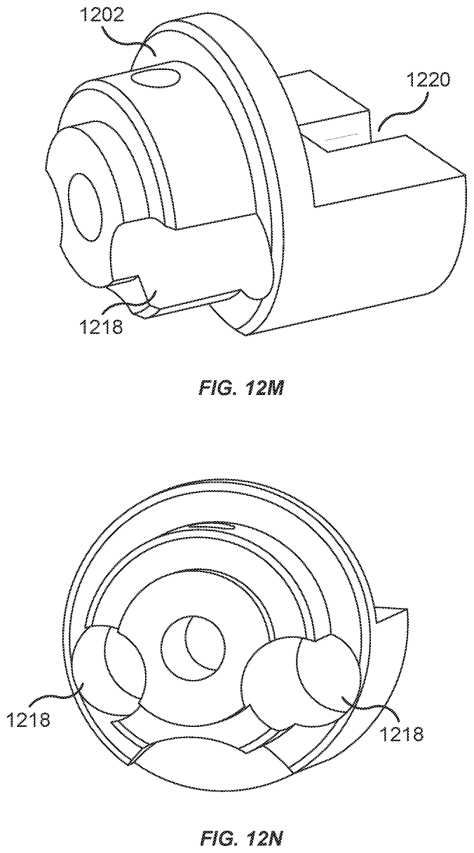

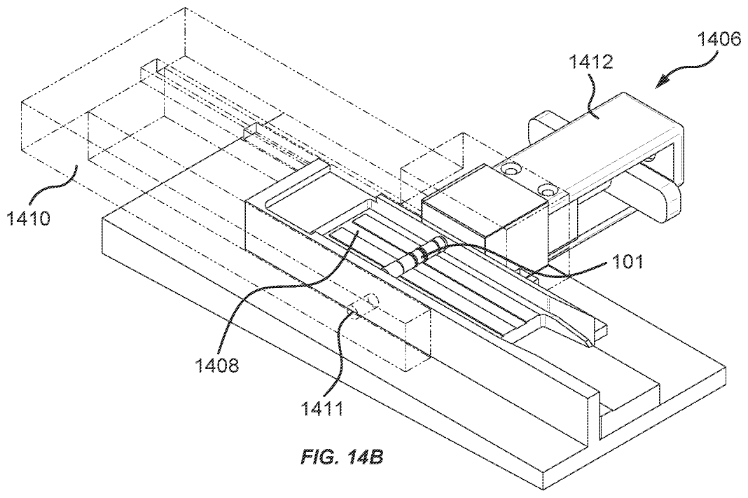

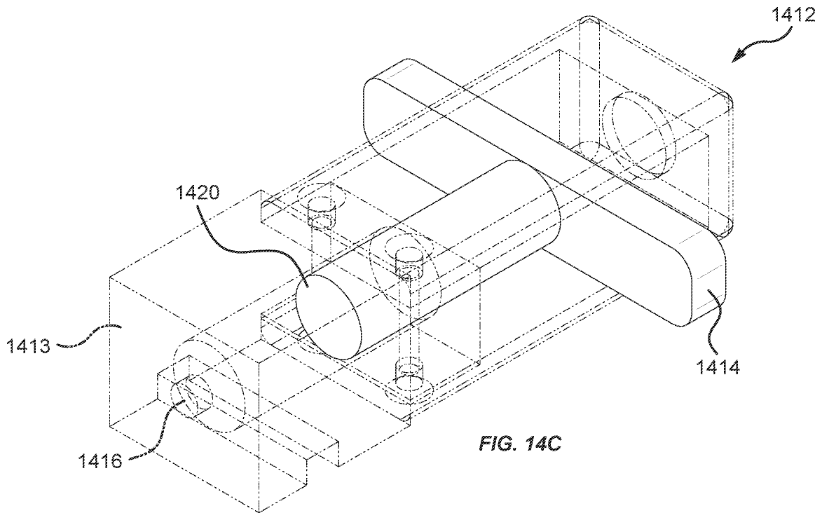

In some aspects, as shown in FIG. 4, the process 400 may include a step 408 of attaching a hydrogel film 409 to a product 101. In some aspects, the hydrogel film 409 may be attached to the product 101 using a manual process. In some alternative aspects, the hydrogel film 409 may be attached to the product 101 using a hydrogel film attachment tool (e.g., the hydrogel film attachment tool 1100 shown in FIGS. 11A-11C, the hydrogel film attachment tool 1150 shown in FIGS. 11D-11I, the hydrogel film attachment tool 1200 shown in FIGS. 12A-12O, or the hydrogel film attachment tool 1400 shown in FIGS. 14A-14C).

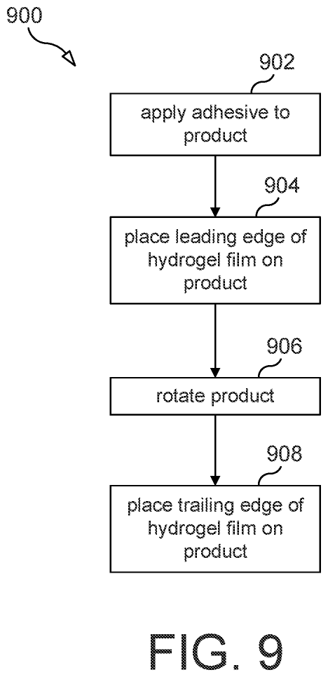

FIG. 9 is a flowchart illustrating a process 900 for attaching a hydrogel film 409 to a product 101. In some aspects, the process 900 may be performed in step 408 of the process 400 illustrated in FIG. 4. In some aspects, the process 900 may be a manual process for attaching the hydrogel film 409 to the product 101.

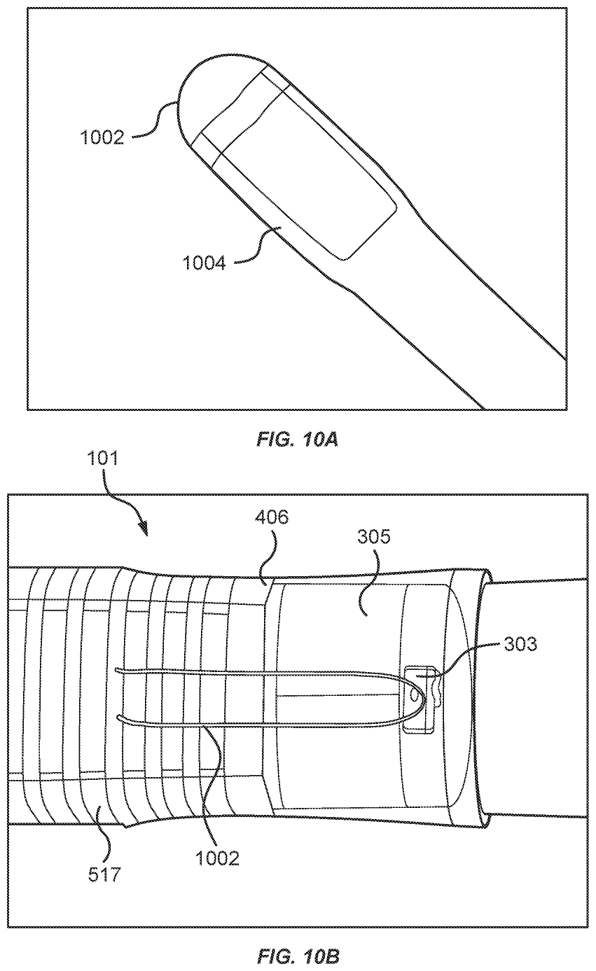

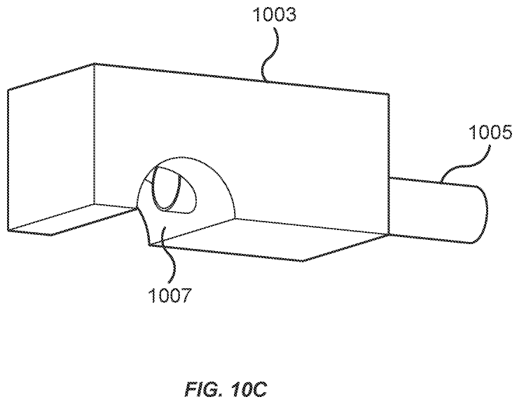

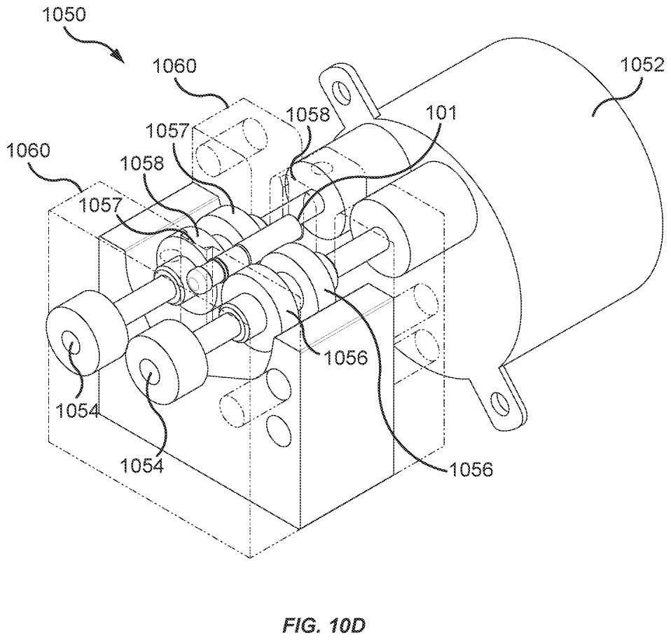

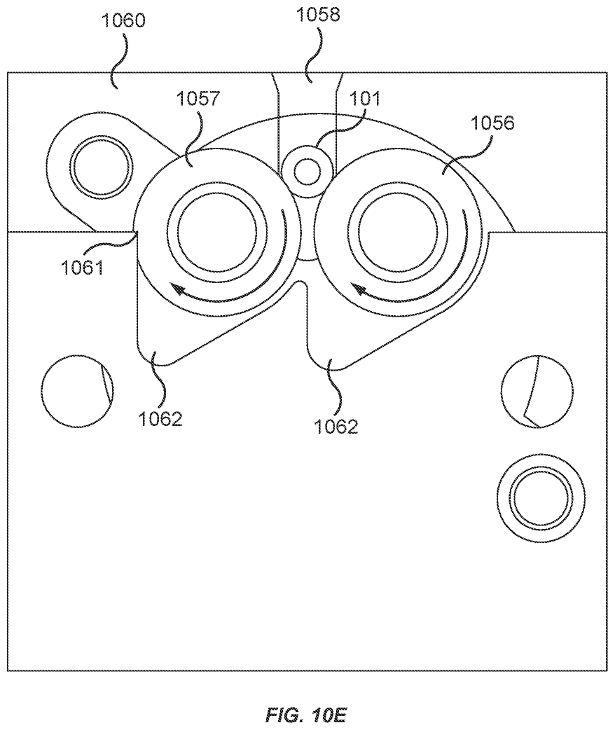

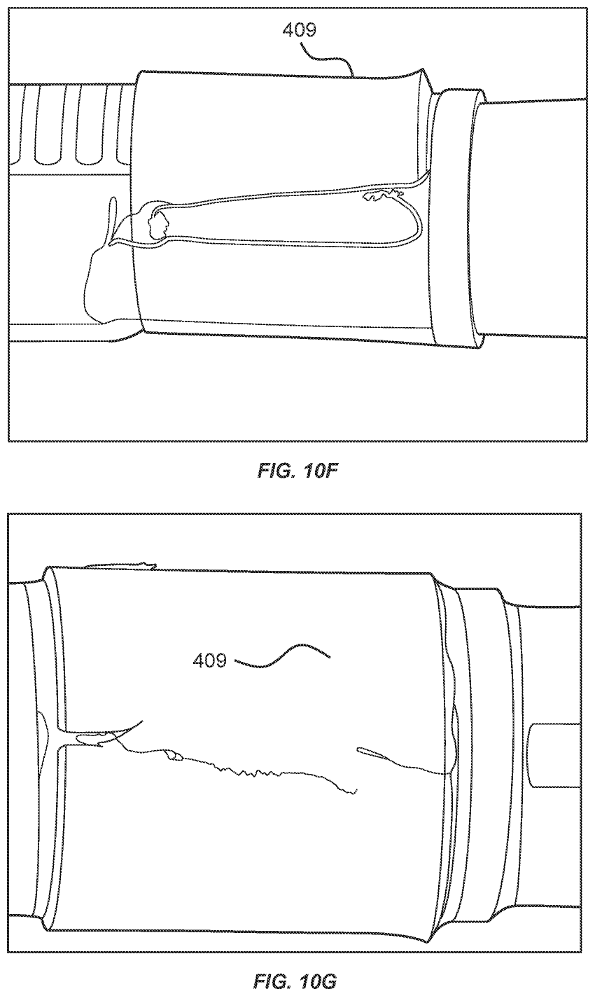

In some aspects, as shown in FIG. 9, the process 900 may include a step 902 of applying adhesive 1002 to a product 101. In some aspects, as shown in FIG. 10A, the adhesive 1002 may be applied using a tip 1004. In some aspects, the tip 1004 may be flat tip (e.g., an oval flat tip such as, for example, an 18-G oval flat tip). In some aspects, as shown in FIG. 10B, the adhesive 1002 may be applied onto the housing 406 of the product 101.

In some alternative aspects, as shown in FIG. 10C, the adhesive 1002 may be applied to the product 101 using a spreading tool 1003. In some aspects, the spreading tool 1003 may be made of a soft material, such as, for example and without limitation, rubber. In some aspects, the spreading tool 1003 may spread the adhesive 1002 to a defined area of the product 101 using a soft surface 1007 which is pressed onto the surface of the product 101. In some aspects, the spreading tool 1003 may be integrated with a dispensing needle 1005. In some aspects, the needle 1005 may dispense a drop of the adhesive 1002. In some aspects, the spreading tool 1005 may move on the product 101 (or the product 101 may rotate) to spread the adhesive 1002 on the product 101. In some aspects, the dispensing and/or position of the adhesive 1002 may be accomplished through an automated system.

In some other alternative aspects, as shown in FIGS. 10D and 10E, an adhesive application tool 1050 may be used to apply the adhesive 1002 on the product 101. In some aspects, the adhesive application tool 1050 may include a motor 1052, one or more drive shafts 1054, one or more first rollers 1056, one or more second rollers 1057, and one or more holders 1060. In some aspects, the product 101 may be placed in one or more slots 1058 in the one or more holders 1060. In some aspects, the product 101 in the one or more slots 1058 may rest on the one or more rollers 1056 and the one or more second rollers 1057. In some aspects, the first and second rollers 1056 and 1057 may be, for example and without limitation, cylindrical rollers. In some aspects, the first and second rollers 1056 and 1057 may be, for example and without limitation, rubber rollers. In some aspects, the adhesive 1002 may be deposited onto the one or more first rollers 1056 (e.g., onto the top(s) of the one or more rollers 1056), and/or the one or more first rollers 1056 may be partially submerged in a pool of adhesive 1002. In some aspects, the one or more first rollers 1056 may rotate and deposit the adhesive 1002 on the product 101. In some aspects, the one or more second rollers 1057 may rotate and remove excess adhesive from the product 102. In some aspects, as shown in FIG. 10E, the adhesive application tool 1050 may include an edge 1061, which may act as a squeegee and remove the excess adhesive from the one or more second rollers 1057. In some aspects, as shown in FIG. 10E, the adhesive application tool 1050 may include one or more depressions 1062 in which excessive adhesive from the one or more first rollers 1056 and/or the one or more second rollers 1057 pools. In some aspects, the first and second rollers 1056 and 1057 may rotate and spin the product 101 and set number of times before the product 101 is removed from the adhesive application tool 1050. In some aspects, the rollers 1056 and 1057 may deposit a precise amount of the adhesive 1002 on the product 101 through the rotational motion of the first and second rollers 1056 and 1057 and the use of edge 1061 to remove excess adhesive.

In some aspects, as shown in FIG. 9, the process 900 may include a step 904 of placing a first edge (e.g., a leading edge) of the hydrogel film 409 on the product 101. In some aspects, as shown in FIG. 10F, the step 904 may include placing the first edge of the hydrogel film 409 in the adhesive 1002 on the product 101. In some aspects, the adhesive 1002 may be a biocompatible adhesive. In some aspects, the adhesive 1002 may include a cyanoacrylate. In some aspects, the adhesive 1002 may include octyl-cyanoacrylate, N-butyl-cyanoacrylate, and/or 2-ethyl cyanoacrylate. In some aspects, the adhesive 1002 may additionally or alternatively include silicones, siloxanes, acrylates, epoxy resins, and/or polyurethanes.

In some aspects, as shown in FIG. 9, the process 900 may include a step 906 of rotating the product 101. In some aspects, the step 906 may include pressing the hydrogel film 409 against the product 101 as the product 101 rotates.

In some aspects, as shown in FIG. 9, the process 900 may include a step 908 of placing a second edge (e.g., a trailing edge) of the hydrogel film 409 on the product 101. In some aspects, as shown in FIG. 10G, the step 908 may include placing the second edge of the hydrogel film 409 in the adhesive 1002 on the product 101. In some aspects, the step 908 may include ensuring that the seam between the first and second edges of the hydrogel film 409 is flat (e.g., with no edges protruding).

In some aspects, the hydrogel film 409 may be attached to the product 101 in step 408 of the process 400 illustrated in FIG. 4 using the hydrogel film attachment tool 1100 shown in FIGS. 11A-11C. In some aspects, the hydrogel film attachment tool 1100 may include a housing 1102 (e.g., a cylindrical housing), a structure 1104 in the housing 1102, and a base 1112. In some aspects, the structure 1104 may include one or more magnets 1106. In some aspects, the one or more magnets 1106 may be configured to align the product 101 in a particular orientation (e.g., with a window of the product 101 down). In some aspects, the structure 1104 may include one or more magnets 1106 on one side of the product 101 and one or more magnets 1106 on the other side of the product 101. In some aspects, the housing 1102 may include one or more openings 1110. In some aspects, the structure 1104 may include one or more clips 1108 configured to interact with the one or more openings 1110 an lock the structure 1104 and one or more magnets 1106 in a down position, as shown in FIG. 11A. In some aspects, releasing the one or more clips 1108 may result in the structure 1104 moving to the up position shown in FIG. 11B, which may release the product 101 from the one or more magnets 1106.

In some aspects, as shown in FIGS. 11A and 11B, the housing 1102 may be configured to extend into and be held in place by the base 1112. In some aspects, the base 1112 may include a fillet 1116 (see FIG. 11C). In some aspects, the fillet 1116 may ensure proper orientation of the housing 1102 and structure 1104 in the base 1112. In some aspects, the base 1112 may include a recess 1118 (e.g., a rounded recess) configured to hold the product 101. In some aspects, the base 1112 may include one or more recesses 1120 (e.g., rounded recesses) configured to allow the hydrogel film 409 curve around the product 101. In some aspects, the base 1112 may include one or more ridges 1122 configured to reduce (or prevent) the hydrogel film 409 from sticking to the base 1112 (e.g., sticking through suction).

In some alternative aspects, the hydrogel film 409 may be attached to the product 101 in step 408 of the process 400 illustrated in FIG. 4 using the hydrogel film attachment tool 1150 shown in FIGS. 11D-11I. In some aspects, the hydrogel film attachment tool 1150 may include a housing 1152 (e.g., a cylindrical housing), a structure 1154 in the housing 1152, a base 1158, and/or a holder 1160. In some aspects, the housing 1152 may include a slot 1153. In some aspects, the structure 1154 may include one or more magnets 1156. In some aspects, the structure 1154 may be moveable in the housing 1152 between a raised position, as shown in FIG. 11D, and a lowered position, as shown in FIG. 11E.

In some aspects, as shown in FIG. 11E, the product 101 may be placed in the slot 1153 of the housing 1152. In some aspects, with the structure 1154 in the lowered position as shown in FIG. 11E, the one or more magnets 1156 may hold the product 101 in place in the slot 1153. In some aspects, the one or more magnets 1156 may be configured to align the product 101 in a particular orientation (e.g., with a window of the product 101 down). In some aspects, the structure 1154 may include one or more magnets 1156 on one side of the product 101 and one or more magnets 1156 on the other side of the product 101.

In some aspects, as shown in FIG. 11F, the housing 1152 may be aligned with the base 1158, and the housing 1152 and structure 1154 may be lowered at least partially into the base 1158. In some aspects, the base 1158 may include a fillet 1161 (see FIGS. 11D and 11E). In some aspects, the fillet 1161 may ensure proper orientation of the housing 1102 and structure 1104 in the base 1112. In some aspects, the base 1158 may include a recess 1159 (e.g., a rounded recess) configured to hold the product 101. In some aspects, as shown in FIGS. 11D and 11E, the base 1112 may include one or more recesses 1163 (e.g., rounded recesses) configured to allow the hydrogel film 409 curve around the product 101. In some aspects, as shown in FIG. 11F, the product 101 may be located in the recess 1159 when the housing 1152 and the structure 1154 are lowered into the base 1158. In some aspects, at least a first edge of the hydrogel film 409 may be attached to the product 101 when the product 101 is placed in the recess 1159. In some aspects, as shown in FIG. 11F, the base 1158 may be configured such that, when the product 101 is located in the recess 1159, the product 101 extends from the base 1158.

In some aspects, as shown in FIG. 11G, the holder 1160 may be slid onto the portion of the product 101 that extends from the base 1158. In some aspects, the holder 1160 may be used to grasp the product 1106 in the recess 1159 of the base 1158. In some aspects, the holder 1160 may be made from a slightly flexible material, which may allow for easier handling of the product 101. In some aspects, the holder 1160 may be used to rotate the product 1106 to wrap the hydrogel film 409 around the product 101 and/or to press the product 101 against the hydrogel film 409 for attachment of the hydrogel film 409. In some aspects, as shown in FIG. 11H, the housing 1152 and the structure 1154 may be removed from the base 1158. In some aspects, as shown in FIG. 11H, the holder 1160 may hold the product 101 in place in the recess 1159 of the base 1158 as the housing 1152 and the structure 1154 are removed from the base 1158. In some aspects, as shown in FIG. 11I, the holder 1160 may be used to remove the product 101 from the base 1152.

In some alternative aspects, the hydrogel film 409 may be attached to the product 101 in step 408 of the process 400 illustrated in FIG. 4 using the hydrogel film attachment tool 1200 shown in FIGS. 12A-12N. In some aspects, as shown in FIGS. 12A-12C, the hydrogel film attachment tool 1200 may include a base 1210. In some aspects, as shown in FIGS. 12A and 12B, the hydrogel film attachment tool 1200 may include one or more product cradles 1202 configured to hold the product 101. In some aspects, as shown in FIGS. 12A and 12B, the tool 1200 may further include one or more magnets 1204 configured to hold the product 101 in the one or more product cradles 1202. In some aspects, the one or more product cradles 1202 may be removable (e.g., held in place by a set screw), which allow the one or more product cradles 1202 to be cleaned easily.

In some aspects, as shown in FIGS. 12A-12C, the hydrogel film attachment tool 1200 may include a roller 1206 configured to attach a hydrogel film 409 to the product 101. In some aspects, the roller 1206 may be positioned initially below the product 101, as shown in FIG. 12A. In some aspects, the roller 1206 may be in this position when the product 101 is placed in the one or more product cradles 1202. In some aspects, to attach the hydrogel film 409 to the product 101, the roller 1206 may move (e.g., rotate) from the initial position approximately 180 degrees in one direction (e.g., the clockwise direction), as shown in FIG. 12B, to attach the hydrogel film 409 to one side of the product 101. In some aspects, the roller 1206 may then move to rotate in the opposite direction (e.g., the counterclockwise direction) back to the initial position and then from the initial position approximately 180 degrees, as shown in FIG. 12C, to apply the hydrogel film 409 to the other side of the product 101. In some aspects, hydrogel film attachment tool 1200 may include mechanical stops configured to prevent the roller 1206 from moving more than approximately 180 degrees in one direction (relative to the initial position) and from moving more than 180 degrees in the other direction (relative to the initial position).

In some aspects, the hydrogel film attachment tool 1200 may include one or more roller actuators 1208 (e.g., one or more geared rollers) configured to move (e.g., rotate) the roller 1206 relative to the product 101. In some aspects, the one or more roller actuators 1208 may allow manual control of movement of the roller 1206 relative to the product 101. In some aspects, the one or more roller actuators 1208 may cause movement of the roller 1206 relative to the product 101 by applying radial force without pulling on the hydrogel film 409. In some aspects, as shown in FIG. 12H, the one or more roller actuators 1208 may include one or more grips on the outer periphery, and the one or more grips may make the one or more roller actuators 1208 easier to use manually. In some alternative aspects, the hydrogel film attachment tool 1200 may include one or more motors for motorized movement of the roller 1206.

In some aspects, as shown in FIGS. 12D-12G, the roller 1206 may include a cutout or slot 1212. In some aspects, the slot 1212 may allow the roller 1206 to be removed easily (e.g., for cleaning). In some aspects, the slot 1212 may have a width of ⅛″. In some aspects, the slot 1212 may allow the roller 1206 to be slid into place and/or removed without disassembly of main assembly. In some aspects, a screw may hold the roller 1206 in place.

In some aspects, as shown in FIGS. 12I and 12J, the hydrogel film attachment tool 1200 may include one or more mounts 1214 and one or more shafts 1216 that connect a product cradle 1202 to a mount 1214. Although the shaft 1216 is illustrated as having a circular cross-section in FIG. 12I, this is not required, and, in some alternative aspects, one or more of the shafts 1216 may have a cross-section with a different shape (e.g., an oval, a square, a diamond, or a rectangular cross-section). In some aspects, a shaft having a non-circular cross-section may improve alignment. In some aspects, a product cradle 1202 may be slid out from a mount 1214 for removal (e.g., after removing one or more screws), and a new product cradle 1202 may be slid in.

In some aspects, as shown in FIGS. 12K and 12M, the one or more product cradles 1202 may include a slot 1220 configured to receive the product 101. In some aspects, as shown in FIGS. 12K-12N, the one or more product cradles 1202 may include one or more magnet holes 1218 each configured to hold a magnet 1204. In some aspects, the magnets 1204 may be glued in place in the magnet holes 1218. In some aspects, as shown in FIGS. 12K and 12N, the one or more magnet holes 1218 may be proximate to the slot 1220. In some alternative aspects, as shown in FIGS. 12M and 12N, the one or more magnet holes 1218 may be drilled from the front. In some aspects, the one or more product cradles 1202 may comprise stainless steel and/or may be cleaned by a cleaning solution (e.g., acetone).

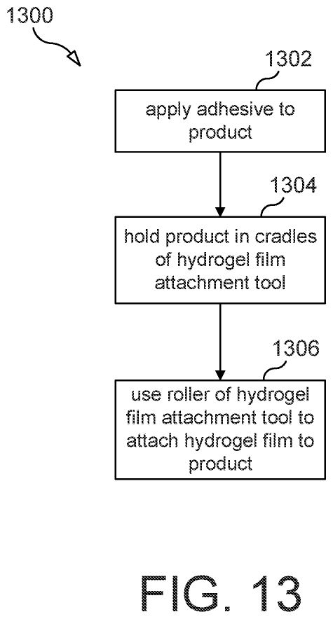

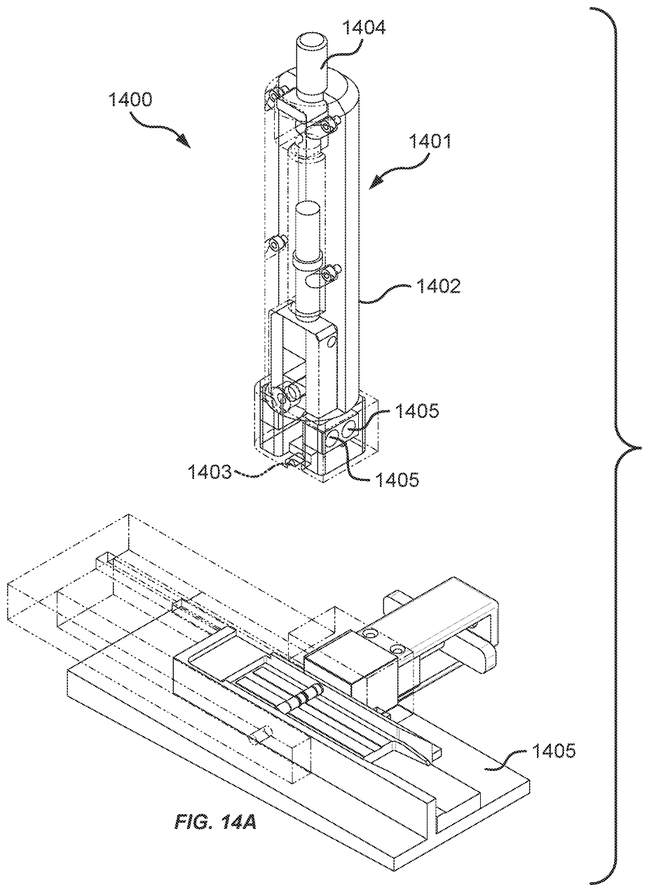

FIG. 13 is a flowchart illustrating a process 1300 for attaching a hydrogel film 409 to a product 101. In some aspects, the process 1300 may be performed in step 408 of the process 400 illustrated in FIG. 4. In some aspects, the process 1300 may attach the hydrogel film 409 to the product 101 using a hydrogel film attachment tool (e.g., the hydrogel film attachment tool 1200 illustrated in FIGS. 12A-12N).

In some aspects, as shown in FIG. 13, the process 1300 may include a step 1302 of applying adhesive 1002 to a product 101. In some aspects, as shown in FIG. 10A, the adhesive 1002 may be applied using a tip 1004. In some aspects, the tip 1004 may be flat tip (e.g., an oval flat tip such as, for example, an 18-G oval flat tip). In some alternative aspects, as shown in FIG. 10C, the adhesive 1002 may be applied using a spreading tool 1003, which may be integrated with a dispensing needle 1005. In some alternative aspects, as shown in FIGS. 10D and 10E, the adhesive 1002 may be applied using an adhesive application tool 1050. In some aspects, as shown in FIG. 10B, the adhesive 1002 may be applied onto the housing 406 of the product 101.

In some aspects, as shown in FIG. 13, the process 1300 may include a step 1304 of holding the product 101 in one or more product cradles 1202 of the hydrogel film attachment tool 1200. In some aspects, holding the product in the one or more product cradles 1202 in step 1304 may include using one or more magnets 1204 of the hydrogel film attachment tool 1200 to hold the product 101 in the one or more product cradles 1202.

In some aspects, as shown in FIG. 13, the process 1300 may include a step 1306 of using a roller 1206 of the hydrogel film attachment tool 1200 to attach the hydrogel film 409 to the product 101. In some aspects, using the roller 1206 to attach the hydrogel film 409 to the product 101 may include rotating the roller 180 degrees in one of the clockwise and counterclockwise directions (e.g., as shown in FIG. 12B) and then rotating the roller 180 degrees in the other of the clockwise and counterclockwise directions (e.g., as shown in FIG. 12C).

In some alternative aspects, the hydrogel film 409 may be attached to the product 101 in step 408 of the process 400 illustrated in FIG. 4 using the hydrogel film attachment tool 1400 shown in FIGS. 14A-14C. In some aspects, as shown in FIG. 14A, the hydrogel film attachment tool 1400 may include first edge attachment tool 1401 and a film rolling tool 1406. In some aspects, the first edge attachment tool 1401 may include a housing 1402 (e.g., a cylindrical housing) and a structure 1404 in the housing 1402. In some aspects, the housing 1402 and structure 1404 may be similar to the housing 1152 and structure 1154, respectively, of the hydrogel film attachment tool 1150 shown in FIGS. 11D and 11E.

In some aspects, the housing 1402 may include a slot 1403. In some aspects, the structure 1404 may include one or more magnets 1405. In some aspects, the structure 1404 may be moveable in the housing 1402 between a raised position and a lowered position (see FIGS. 11D and 11E, respectively). In some aspects, the product 101 may be placed in the slot 1403 of the housing 1402, and, at least in the lowered position, the one or more magnets 1405 may hold the product 101 in place in the slot 1153 (see FIG. 11E). In some aspects, the one or more magnets 1405 may be configured to align the product 101 in a particular orientation (e.g., with a window of the product 101 down). In some aspects, the structure 1404 may include one or more magnets 1405 on one side of the product 101 and one or more magnets 1405 on the other side of the product 101. In some aspects, as shown in FIG. 14A, the first edge attachment tool 1401 may be used to place the product 101 on the film rolling tool 1406.

In some aspects, the film rolling tool 1406 may include a film rolling ramp 1408, a slider 1410, and/or a transfer tool 1412. In some aspects, a hydrogel film 409 may be placed on the film rolling ramp 1408. In some aspects, the hydrogel film 409 may be placed on the top of the film rolling ramp 1408. In some aspects, the product 101 may be placed on the hydrogel film 409 on the film rolling ramp 1408 by the first edge attachment tool 1401. In some aspects, placing the product 101 on the hydrogel film 409 on the film rolling ramp 1408 may attached a first edge of the hydrogel film 409 to the product 101. In some aspects, the film rolling tool 1406 may include one or more alignment features for accurate positioning of the product 101 in the first edge attachment tool 1401 above the hydrogel film 409 on the film rolling ramp 1408.

In some aspects, the hydrogel film 409 may be attached to the product 101 by rolling the product 101 along a path on the film rolling ramp 1408 (with or without the aid of magnetic forces). In some aspects, the film rolling ramp 1408 may have a gradient steep enough for gravity alone to cause the product 101 to roll down the film rolling ramp 1408 and over the hydrogel film 409 for attachment of the hydrogel film 409 to the product 101. In some alternative aspects, as shown in FIG. 14B, the film rolling tool 1406 may (in addition to or as an alternative to a gradient of the film rolling ramp 1408) include a slider 1410, and the slider 1410 may be used to cause the product 101 to roll down the film rolling ramp 1408 and over the hydrogel film 409 for attachment of the hydrogel film 409 to the product 101. In some aspects, the slider 1410 may include one or more magnets 1411 that pull the product 101 down the film rolling ramp 1408 as the slider 1410 is moved.

In some aspects, as shown in FIGS. 14B and 14C, the film rolling tool 1406 may include the transfer tool 1412, and the transfer tool 1412 may be used to remove the product 101 from the film rolling ramp 1408 after attachment of the hydrogel film 409 to the product 101. In some aspects, the transfer tool 1412 may remove the product 101 from the end of the film rolling ramp 1408 and/or may release the product 101 into another location for further processing (e.g., inspection, washing, and/or drying). In some aspects, at the end of the film rolling ramp 1408, the product 101 may slide into the transfer tool 1412.

In some aspects, as shown in FIG. 14C, the transfer tool 1412 may include a structure 1413 and a plunger 1414. In some aspects, the structure 1413 may include a slot 1416. In some aspects, the plunger 1414 may include a magnet 1420. In some aspects, the magnet 1420 in the plunger 1414 may pull the product 101 from the film rolling ramp 1408 into the slot 1416 of the structure 1413. In some aspects, the plunger 1414 may be pulled back (e.g., with the aid a spring (not shown)), and the product 101 may be released (e.g., into a slot of a drying rig).

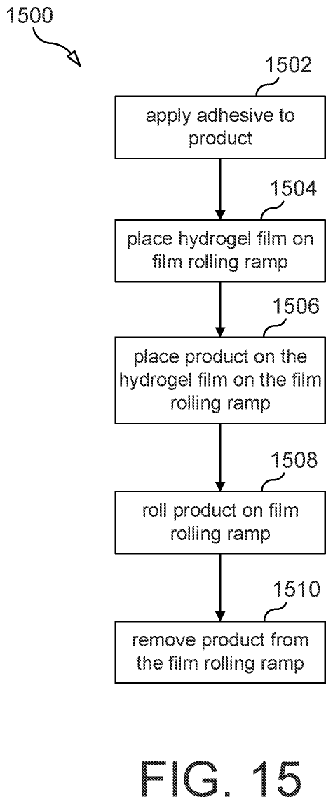

FIG. 15 is a flowchart illustrating a process 1500 for attaching a hydrogel film 409 to a product 101. In some aspects, the process 1500 may be performed in step 408 of the process 400 illustrated in FIG. 4. In some aspects, the process 1500 may attach the hydrogel film 409 to the product 101 using a hydrogel film attachment tool (e.g., the hydrogel film attachment tool 1400 illustrated in FIGS. 14A-14C).

In some aspects, as shown in FIG. 15, the process 1500 may include a step 1502 of applying adhesive 1002 to a product 101. In some aspects, as shown in FIG. 10A, the adhesive 1002 may be applied using a tip 1004. In some aspects, the tip 1004 may be flat tip (e.g., an oval flat tip such as, for example, an 18-G oval flat tip). In some alternative aspects, as shown in FIG. 10C, the adhesive 1002 may be applied using a spreading tool 1003, which may be integrated with a dispensing needle 1005. In some alternative aspects, as shown in FIGS. 10D and 10E, the adhesive 1002 may be applied using an adhesive application tool 1050. In some aspects, as shown in FIG. 10B, the adhesive 1002 may be applied onto the housing 406 of the product 101.

In some aspects, as shown in FIG. 15, the process 1500 may include a step 1504 of placing a hydrogel film 409 on a film rolling ramp 1408 of the hydrogel film attachment tool 1400.

In some aspects, as shown in FIG. 15, the process 1500 may include a step 1506 of placing the product 101 on the hydrogel film 409 on the film rolling ramp 1408. In some aspects, the first edge attachment tool 1401 may be used to place the product 101 on the hydrogel film 409. In some aspects, the product 101 may be placed on the hydrogel film 409 such that a first edge of the hydrogel film 409 is attached to the product 101.

In some aspects, as shown in FIG. 15, the process 1500 may include a step 1508 of rolling the product 101 on (e.g., down) the film rolling ramp 1408 and over the hydrogel film 409 (e.g., using the slider 1410). In some aspects, rolling the product 101 down the film rolling ramp 1408 and over the hydrogel film 409 may attach the hydrogel film 409 to the product 101.

In some aspects, as shown in FIG. 15, the process 1500 may include a step 1510 of removing the product 101 to which the hydrogel film 409 is attached from the film rolling ramp 1408 (e.g., using the transfer tool 1412).

In some aspects, as shown in FIG. 4, the process 400 may include a step 410 of inspecting the hydrogel film 409. In some aspects, the step 410 may include determining whether the hydrogel film 409 attached to the product 101 passes the inspection. In some aspects, as shown in FIG. 4, if the hydrogel film 409 is determined to not pass the inspection, the process 1300 may proceed to a step 411 of removing all or a portion of the hydrogel film 409 from the product 101 and then to back to the step 408 for attachment of another hydrogel film 409 to the product 101. In some aspects, as shown in FIG. 4, if the hydrogel film 409 is determined to pass the inspection, the process 1300 may proceed to a step 412.

In some aspects, the step 412 may include drying the product 101 including the hydrogel film 409 attached to the product 101. In some aspects, as shown in FIG. 4, the process 400 may include a step 414 of applying (e.g., sputtering or dip-coating) a protective material to the hydrogel film 409 attached to the product 101. In some aspects, the protective material may be configured to reduce deterioration of analyte indicator molecules of the hydrogel film 409. In some aspects, the protective material may be configured to catalyze degradation of reactive oxygen species (ROS). In some aspects, the protective material may include platinum, palladium, iridium, molybdenum, and/or silver.

In some aspects, as shown in FIG. 4, the process 400 may additionally or alternatively include a step 416 of applying a second protective material to the hydrogel film 409 attached to the product 101. In some aspects, the second protective material may include iridium and/or molybdenum.

In some aspects, as shown in FIG. 4, the process 400 may include a step 418 of inspecting the device 100 including the product 101 and attached hydrogel film 409. In some aspects, the inspection may include, for example and without limitation, an electrical test (e.g., of circuitry of the product 101). In some aspects, as shown in FIG. 4, the process 400 may include a step 420 of rinsing and drying the device 100. In some aspects, as shown in FIG. 4, the process 400 may include a step 422 of inspecting the device 100 (e.g., a final inspecting including, for example, a visual inspection). In some aspects, if an inspection is failed in step 418 or 422, the device may be removed from the process 400. In some aspects, if the device 100 passes the inspections in 418 and 422, one or more devices 100 may be consolidated and/or packaged.

In some aspects, the same amount of monomer solution 610 that is used to grow hydrogel films 409 on one hundred products 101 according to the conventional method may be used to produce forty hydrogel sheets 612 (e.g., in step 402 of the process 400), which may each be cut into 60 sheets each to produce 2400 hydrogel films 409 (e.g., in step 404 of the process 400). Thus, the process 400 for producing and attaching a hydrogel film 409 may be more efficient than the conventional method of growing hydrogel films on products 101.

In some multiple hydrogel film 409 aspects, the steps 408 and 410 (and step 411 if needed) of the process 400 may be repeated for each of the multiple hydrogel films 409. In some multiple hydrogel film 409 aspects, each of the multiple hydrogel film 409 may be the same. However, this is not required, and, in some alternative multiple hydrogel film 409 aspects, the multiple hydrogel films 409 may include at least one or more first hydrogel films and one or more second hydrogel films that are different than the one or more first hydrogel films. In some aspects including first and second hydrogel films that are different, the first hydrogel film may include first analyte indicator molecules 311 configured to reversibly bind a first analyte and emit an amount of first emission light 331 indicative of an amount of the first analyte indicator molecules 311 that have reversibly bound the first analyte (e.g., in response to being irradiated with excitation light 329), the second hydrogel film may include second analyte indicator molecules 311 configured to reversibly bind a second analyte and emit an amount of second emission light 331 indicative of an amount of the second analyte indicator molecules 311 that have reversibly bound the second analyte, and the second analyte may be different than the first analyte. In some aspects including at least first and second hydrogel films that are different, steps 402, 404, and 406 of the process 400 may be repeated for each of the different hydrogel films. In some aspects, the same mold 600 and hydrogel cutting tool 700 may be used to produce first and second hydrogel sheets and cut them into the first and second hydrogel films, respectively. However, this is not required, and, in some alternative aspects, different molds 600 and/or different hydrogel cutting tool 700 may be used to produce first and second hydrogel sheets and cut them into the first and second hydrogel films, respectively.

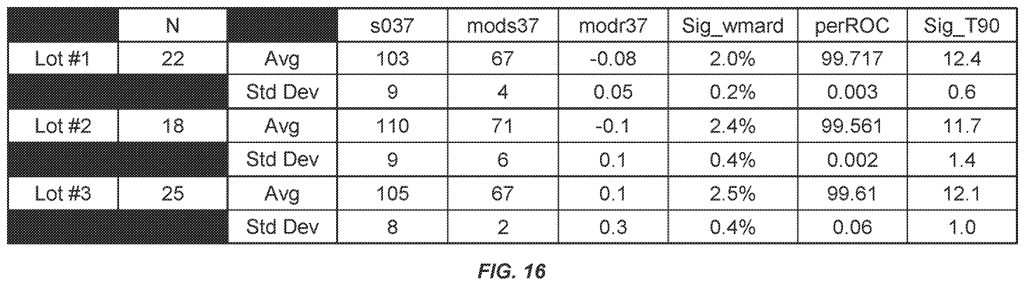

FIG. 16 shows the experimental results of repeatability and reproducibility (R&R) testing of devices 100 including a hydrogel film 409 attached to a product 101 according to some aspects. The experimental results of the R&R testing show that the process 400 for producing and attaching a hydrogel film 409 on a product 101 to be repeatable and reproducible. In FIG. 16, S037 is a baseline signal, mods 37 is a signal channel modulation signal, modr37 is a reference channel modulation signal, Sig_wmard is the weighted average relative difference, perROC is the rate of change in the signal channel, and Sig_T90 is the responsivity time for change in glucose.

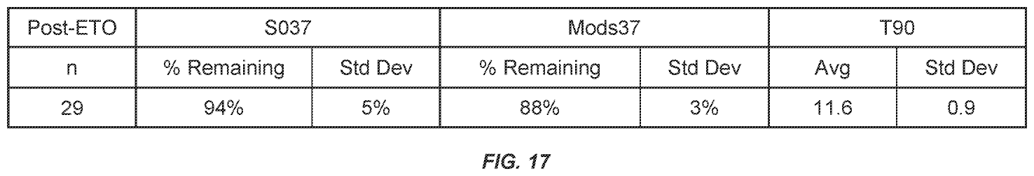

FIG. 17 shows experimental results of functionality testing of devices 100 including a hydrogel film 409 attached to a product 101 post-sterilization according to some aspects. In some aspects, sterilization was carried out on a group of twenty-nine devices 100 including a hydrogel film 409 attached to a product 101. The sterilization was an ethylene oxide (ETO) sterilization, but different types of sterilization may be used in some alternative aspects. A quality control process was performed post-sterilization. The sensor functional test output of FIG. 17 shows retention of device parameters. In FIG. 17, S037 is a baseline signal, Mods 37 is a signal channel modulation signal, and T90 is the responsivity time for change in glucose.

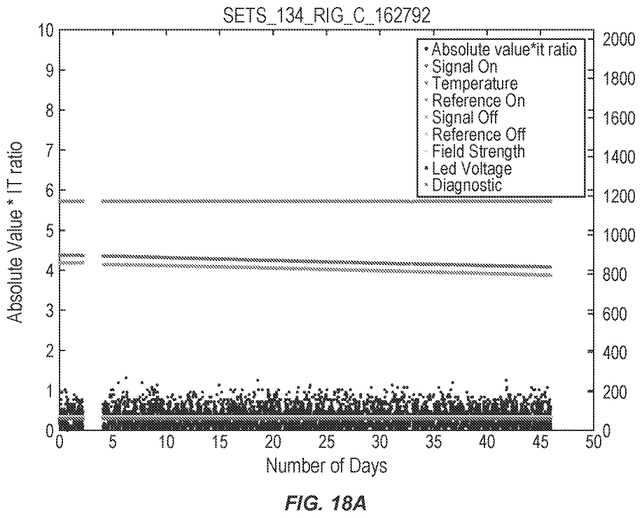

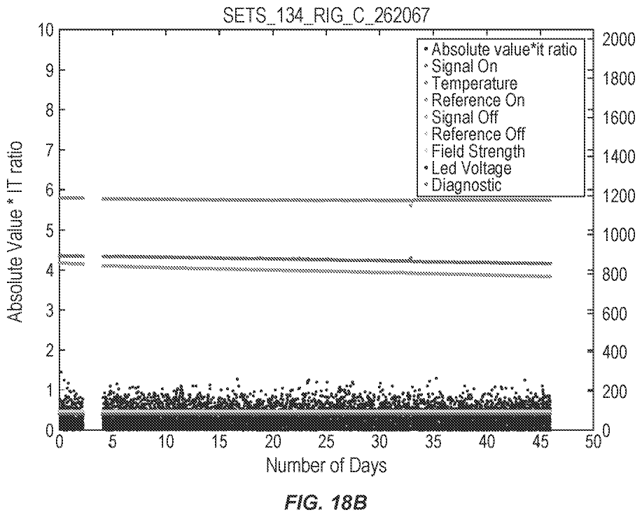

FIGS. 18A and 18B show the experimental results of stability testing on hydrogel films grown on products and hydrogel films attached to products embodying aspects of the present invention, respectively. FIG. 18A and FIG. 18B show that the devices 100 including a hydrogel film 409 attached to a product 101 according to aspects of the invention perform similarly to hydrogel films grown on a product according to conventional methods.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

What is claimed is:

1. A process comprising:
injecting a monomer solution into a mold;
polymerizing the monomer solution in the mold to produce a hydrogel sheet;
cutting the hydrogel sheet to produce one or more hydrogel films; and
attaching a hydrogel film of the one or more hydrogel films to a product.

2. The process of claim 1, wherein the mold comprises first and second plates and one or more clips configured to hold the first and second plates together, wherein the monomer solution is injected between the first and second plates.

3. The process of claim 2, wherein the first plate is a glass plate, the second plate is a stamped plate, and the one or more clips are plastic clips.

4. The process of claim 1, further comprising assembling the mold.

5. The process claim 1, wherein injecting the monomer solution into the mold comprises injecting the monomer solution into an injection port of the mold.

6. The process of claim 1, wherein cutting the hydrogel sheet to produce one or more hydrogel films comprises using a hydrogel cutting tool to partition the hydrogel sheet.

7. The process of claim 6, wherein using the hydrogel cutting tool to partition the hydrogel sheet comprises:
providing the hydrogel sheet between a platform and a cut out sheet of the hydrogel cutting tool, wherein the platform comprises projections, and the cut out sheet comprises openings that mate with the projections of the platform; and
inserting the projections of the platform into the openings of the cut out sheet.

8. The process of claim 1, wherein attaching the hydrogel sheet to the product comprises:
applying an adhesive onto the product;
placing a first edge of the hydrogel film in the adhesive on the product; and
placing a second edge of the hydrogel film in the adhesive on the product.

9. The process of claim 8, wherein attaching the hydrogel sheet to the product comprises rotating the product and pressing the hydrogel film against the product as the product rotates.

10. The process of claim 1, wherein attaching the hydrogel sheet to the product comprises using a hydrogel film attachment tool.

11. The process of claim 10, wherein using the hydrogel film attachment tool comprises:
holding the product in one or more product cradles of the hydrogel film attachment tool; and
using a roller of the hydrogel film attachment tool to attach the hydrogel film to the product.

12. The process of claim 11, wherein holding the product in the one or more product cradles comprises using one or more magnets of the hydrogel film attachment tool to hold the product in the one or more product cradles.

13. The process of claim 11, wherein using the roller to attach the hydrogel film to the product comprises rotating the roller 180 degrees in one of the clockwise and counterclockwise directions and then rotating the roller 180 degrees in the other of the clockwise and counterclockwise directions.

14. The process of claim 1, further comprising determining whether the hydrogel film passes an inspection before attaching the hydrogel film to the product.

15. The process of claim 14, wherein determining whether the hydrogel film passes the inspection comprises determining whether the hydrogel film includes a threshold amount of analyte indicator molecules.

16. The process of claim 1, further comprising determining whether the hydrogel film attached to the product passes an inspection.

17. The process of claim 16, further comprising:
determining that the hydrogel film attached to the product does not pass the inspection;
removing all or a portion of the hydrogel film from the product; and
attaching another hydrogel film to the product.

18. The process of claim 1, further comprising drying the product including the hydrogel film attached to the product.

19. The process of claim 1, further comprising applying a protective material to the hydrogel film attached to the product.

20. The process of claim 19, wherein the protective material is configured to reduce deterioration of analyte indicator molecules of the hydrogel film.

21. The process of claim 19, wherein the protective material is configured to catalyze degradation of reactive oxygen species (ROS).

22. The process of claim 19, further comprising applying a second protective material to the hydrogel film attached to the product.

23. The process of claim 1, wherein:
the hydrogel film of the one or more hydrogel films is a first hydrogel film;
the first hydrogel film is attached to a first portion of the product;
the first hydrogel film includes first analyte indicator molecules configured to reversibly bind a first analyte and emit an amount of first emission light indicative of an amount of the first analyte indicator molecules that have reversibly bound the first analyte;
the process further comprises attaching a second hydrogel film to a second portion of the product;
the second hydrogel film includes second analyte indicator molecules configured to reversibly bind a second analyte and emit an amount of second emission light indicative of an amount of the second analyte indicator molecules that have reversibly bound the second analyte; and
the second analyte is different than the first analyte.

24. The process of claim 23, wherein the monomer solution is a first monomer solution, the mold is a first mold, the hydrogel sheet is a first hydrogel sheet, the one or more hydrogel films are one or more first hydrogel films, and the process further comprises:
injecting a second monomer solution into a second mold, wherein the second monomer solution includes the second analyte indicator molecules;
polymerizing the second monomer solution in the second mold to produce a second hydrogel sheet; and
cutting the second hydrogel sheet to produce one or more second hydrogel films, wherein the second hydrogel film attached to the product is one of the one or more second hydrogel films.

25. A process of using a hydrogel film attachment tool to attach a hydrogel film to a product, the process comprising:
holding the product in one or more product cradles of the hydrogel film attachment tool; and
using a roller of the hydrogel film attachment tool to attach the hydrogel film to the product.

26. The process of claim 25, wherein holding the product in the one or more product cradles comprises using one or more magnets of the hydrogel film attachment tool to hold the product in the one or more product cradles.

27. The process of claim 25, wherein using the roller to attach the hydrogel film to the product comprises rotating the roller 180 degrees in one of the clockwise and counterclockwise directions and then rotating the roller 180 degrees in the other of the clockwise and counterclockwise directions.

28. A hydrogel film attachment tool comprising:
one or more product cradles configured to hold a product; and
a roller configured to attach a hydrogel film to the product.

29. The tool of claim 28, further comprising one or magnets configured to hold the product in the one or more product cradles.

30. An adhesive application tool for applying an adhesive on a product, the adhesive application tool comprising:
one or more first rollers;
one or more second rollers;
one or more holders including one or more slots configured such that the product in the one or more slots rests on the one or more first rollers and the one or more second rollers; and
a motor configured to cause (i) the one or more first rollers to rotate and deposit adhesive on the product and/or (ii) the one more second rollers to rotate and remove excess adhesive from the product.

31. A hydrogel film attachment tool for attaching a hydrogel film to a product, the hydrogel film attach tool comprising:
a housing;
a structure moveably positioned in the housing, wherein the structure comprises one or more magnets configured to hold the product, and the structure is configured to place the product on the hydrogel film.

32. The hydrogel film attachment tool of claim 31, further comprising a base including a recess configured to hold the product.

33. The hydrogel film attachment tool of claim 32, wherein the base is configured such that the product in the recess of the base extends from the base.

34. The hydrogel film attachment tool of claim 31, further comprising a holder.

35. The hydrogel film attachment tool of claim 31, further comprising a film rolling tool.

36. The hydrogel film attachment tool of claim 35, wherein the film rolling tool comprises a film rolling ramp, a slider, and/or a transfer tool.

37. A method for attaching a hydrogel film to a product, the method comprising:
placing a hydrogel film on a film rolling ramp of a hydrogel film attachment tool;
placing the product on the hydrogel film on the film rolling ramp; and
rolling the product on the film rolling ramp and over the hydrogel film.

38. The method of claim 37, further comprising applying adhesive to the product.

39. The method of claim 37, further comprising removing the product from the film rolling ramp.
